(19) United States
(12) Patent Application Publication
(10) Pub. No.: US 2025/0170002 A1
(43) Pub. Date: May 29, 2025

(54) APPARATUS AND METHOD FOR AUTOMATED WHEELCHAIR ASSISTANCE

(71) Applicant: Ryan FREDERICK, Hamburg, PA (US)

(72) Inventor: Ryan FREDERICK, Hamburg, PA (US)

(21) Appl. No.: 19/038,578

(22) Filed: Jan. 27, 2025

(51) Int. Cl. A61G 5/04; A61G 5/02

(52) U.S. Cl. CPC A61G 5/047; A61G 5/022

(57) ABSTRACT

An apparatus and method for automated wheelchair assistance. The automated wheelchair assistance includes a lightweight apparatus for converting a manual wheelchair into an electronic wheelchair, attachable to and removable from a manual wheelchair. The apparatus includes a touch contact sensing technology that is configured to detect the user's hand on the handrims of the rear wheel, and a system that detects the motion of the wheelchair and provides assistive force to the rear wheels of the wheelchair to aid propelling a manual wheelchair. The apparatus uses a network device (e.g., smart phone, electronic tablet, wearable, etc.) in order to move the manual wheelchair to a user from a remote location for use, move the manual wheelchair automatically away from the user after use, and drive the wheelchair without physical input to wheels and control power and speed settings of the manual wheelchair assistance.

### CROSS REFERENCES TO RELATED APPLICATIONS

None.

### FIELD OF INVENTION

This application relates to manual wheelchairs. More specifically, it relates to an apparatus and method for automated wheelchair assistance.

### BACKGROUND OF THE INVENTION

A manual wheelchair is a mobility device that uses hand-rimmed wheels to help people with limited mobility move around, without the need for a motor or electricity. A user propels the manual wheelchair by grabbing the handrims on the rear wheels and moving them forward, backward, and in a pivot.

Manual wheelchairs usually have two sets of wheels: A pair in front, called caster wheels and a pair in the back called rear wheels. Manual wheelchairs require physical effort and may limit mobility in some situations. Users also need upper body strength and dexterity to operate them effectively.

Power wheelchairs, also known as power chairs, are designed for people who lack the motor function or cardiovascular strength to operate a manual wheelchair. A power wheelchair is a wheelchair that is propelled by means of an electric motor and a controller such as a joy stick, touch pad, etc. rather than manual power of a user.

Electric wheelchairs are smaller and lighter than power chairs and usually include smaller motors. Electric wheelchairs lack the durability of power chairs, which can be driven outside, across lawns, dirt, sidewalks, and other surfaces.

Power wheelchairs are expensive, heavy and hard to transport in a vehicle. Electric wheelchairs are typically less expensive and lighter than power wheelchairs, but are also hard to transport.

It is desirable to provide a simple solution to turn a manual wheelchair into an automated wheelchair. However, there are many problems trying to provide a solution to automate a manual wheelchair.

One problem is that it is difficult to provide an automated solution that allows the automation to not require a joystick, touchpad or other controller to be installed on the arm rests of the manual wheelchair.

Another problem is that it is difficult to provide an automated solution that allows the automation technology to be activated by simply touching the handrims (i.e., outmost wheels) on the wheels of a manual wheelchair.

Another problem is that it is difficult to provide an automated solution that allows the automation to be deactivated by simply touching the handrims on the wheels of a manual wheelchair.

Another problem is that it is difficult to provide an automated solution that allows the automation to allow a manual wheelchair to continue in a same direction, both wheels at the same speed, when the handrims of the wheels are not being touched at all.

Another problem is that it is difficult to provide an automated solution that allows the automation to reduce the number of pushes on the manual wheelchair wheels by continuing to move a manual wheelchair at a desired speed after releasing the handrims on the wheels, thus increasing the number of push repetitions and associated shoulder and hand grip injuries and fatigue of a wheelchair user.

An increased number of pushes also increases wear pressures on hands, arms and shoulders of a user and increases risk of injury over time and does not compensate for any upper body weakness of the user.

Another problem is that it is difficult to provide an automated solution that allows the automation to use a remote-controlled mobile device such as mobile phone, electronic tablet, computer, wearable device, etc. in order to move the manual wheelchair to a user from a remote location for use and move the manual wheelchair automatically away from the user after use.

Another problem is that it is difficult to provide an automated solution that allows the automation to use a remote-controlled mobile device such as mobile phone, electronic tablet, computer, wearable device, etc. in order to control the manual wheelchair like a power wheelchair.

Another problem is that it is difficult to provide an automated solution that allows the automation to use software applications including Artificial Intelligence (AI) and sensors to collect data to assist in regulating speed, assistance and control of navigation by a user and to determine a precise physical location of a manual wheelchair in the event of an emergency situation.

Another problem is that it is difficult to provide an automated solution that allows the automation to provide a smart speaker that is used to send voice commands to and receive voice commands if the user of the manual wheelchair has a problem with the manual wheelchair and if the user of the manual wheelchair has a medical or health emergency, etc.

Another problem is that it is difficult to provide an automated solution that allows the automation to be light weight and easily attachable to, and removable from a manual wheelchair.

There have been several attempts to provide automation to manual wheelchairs.

For example, U.S. Pat. No. 10,517,780, that issued to Peskin, et al. teaches “Disclosed is a device for converting a manual wheelchair into an electronic wheelchair is provided. The device includes a joystick, a communication unit, a motor, a retractable friction roller, an engagement unit and a power source. The joystick is operably connected to a communication unit. The communication unit is operably connected to a motor. The motor includes an axle connected to a rotor. The retractable friction roller is mounted on the axle. The roller is placed in contact with a wheel of a manual wheelchair. The engagement unit is attached to the manual wheelchair to detachably attach the friction roller and the wheel. The power source is operably connected to the motor and the joystick.”

U.S. Pat. No. 10,322,043, that issued to Richter teaches “The present disclosure describes a system for a providing an assistive driving force to a wheelchair. The system comprises a power assist system which includes a motion sensing system that is configured to detect the motion of the power assist system, and hence of the wheelchair, and a power assist drive system that is configured to provide an assistive drive force. The system also comprises a sensor, such as may be embedded in a wearable wristband, that is configured to detect the motion of a user's hand and that is in communication with the power assist system. The system may be configured to determine whether the wheelchair is being manually pushed based at least in part on the user motion, and to activate an assistive drive force in response to a manual push. The system may also be configured to determine whether the wheelchair is being manually braked based at least in part on the user motion, and to deactivate an assistive drive force in response to a manual brake.”

U.S. Pat. No. 9,944,167, that issued to Biderman et al. teaches “A system, method, and device for operations of an electrically motorized vehicle. The vehicle can utilize an electrically motorized wheel to convert a non-motorized wheeled vehicle to an electrically motorized wheeled vehicle. The electrically motorized wheeled vehicle includes a plurality of electrically motorized wheels, each of the plurality of electrically motorized wheels in communication with at least one other of the plurality of electrically motorized wheels to coordinate operation of the vehicle.

U.S. Pat. No. 4,961,473, that issued to Jones teaches “A kit for converting a hand-powered wheelchair to an electric motor-powered wheelchair is disclosed. The kit includes a pair of DC electric motors, each motor being connected to a drive wheel for rotating the drive wheel. The motors are mounted on the supporting frame of the chair for pivotal movement relative to the frame between a first position with the drive wheel adjacent to but spaced from the rim of one of the large diameter rear wheels of the chair and a second position with the drive wheels in engagement with the wheels so that rotation of the drive wheels will rotate the large wheels and move the chair. Levers are mounted on the frame for moving the motors between the first and second positions. A battery supplies power to the motors through switches that control the flow of electricity to the motors.”

U.S. Published Patent Application US2018/0280213, published by Hancock, et al. teaches “The present disclosure describes devices and systems that can be integrated with a foldable, manual wheelchair to convert the wheelchair into a hybrid chair capable of both manual operation and motor-powered operation. A wheelchair powering device includes a motor that is operatively coupled to a roller member so that rotation of the motor shaft causes rotation of the roller member. The roller member may be engaged against a tire of the wheelchair so that rotation of the roller member causes rotation of the tire via friction between the roller member and tire.”

U.S. Published Patent Application US2014/0262575, published by Richter teaches “The present disclosure describes a motion assistance system for a wheelchair, for example, a powered drive wheel system that can continually drive a wheelchair in a circular or elliptical path. The motion assistance system comprises a mounting mechanism attachable to one or more structural elements of the wheelchair, and a drive linkage pivotable with respect to the mounting mechanism. A drive wheel can be mounted to an end of the drive linkage such that the drive wheel contacts the ground when installed on the wheelchair. The drive wheel comprises a plurality of lateral rollers positioned radially about the circumference of the power drive wheel. The lateral rollers can rotate about an axis tangential to the circumference of the drive wheel in order to facilitate driving the wheelchair in a radial direction.”

The PERMOBIL company, offers an assistive driving system, Smartdrive attachment, for powering a manual wheelchair.

The RGK WHEELCHAIRS company, offers an e-fix solution power assist with a touch screen for powering wheels of manual wheelchairs.

However, these solutions still do not solve all of the problems associated with automating manual wheelchairs. Thus, it is desirable to solve some of the problems associated with automating manual wheelchairs.

### SUMMARY OF THE INVENTION

In accordance with preferred embodiments of the present invention, some of the problems associated with wheelchairs are overcome. A method and apparatus for automated wheelchair assistance is presented.

The automated wheelchair assistance includes a lightweight apparatus for converting a manual wheelchair into an electronic wheelchair, attachable to and removable from a manual wheelchair. The apparatus includes a touch contact sensing technology that is configured to detect the touch contact of a user's hand on the handrims of the wheel, and a system that detects the motion of the wheelchair and provides assistive force to the rear wheels of the wheelchair to aid propelling a manual wheelchair.

While the user's hand is contacting the handrims the motors will also provide a level of assistance if a wheel is accelerating (e.g., the user is pushing the wheel, this helps push the manual wheelchair through a non-paved surface such as grass, gravel, etc.), no assistance if the manual wheelchair is not accelerating (i.e., slowing down the wheel, braking or sitting idle etc.) and assistance if the manual wheelchair is braking. The automated assistance may be provided to the wheels independently to help turn or collectively to move in a straight direction. After the wheel is pushed and no touch contact of the user's hand on the handrims is sensed the automated wheelchair assistance apparatus continues maintaining the manual wheelchair in the desired direction at the desired velocity until touch contact is sensed.

The apparatus may be connected to a network device (e.g., smart phone, electronic tablet, wearable, etc.) in order to move the manual wheelchair to a user from a remote location for use by the user, move the manual wheelchair automatically away from the user after use, drive the wheelchair without physical input to wheels, and control power and speed of the manual wheelchair assistance.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an automated wheelchair assistance apparatus;

FIG. 2A is a block diagram illustrating a three-dimensional (3D) perspective view of an automated wheelchair assistance apparatus;

FIG. 2B is a block diagram illustrating a three-dimensional (3D) perspective view of an automated wheelchair assistance apparatus;

FIG. 3 is a block diagram illustrating a perspective view of manual wheelchair wheels and axle and an automated wheelchair assistance apparatus;

FIG. 4A is a block diagram illustrating a top view of manual wheelchair wheels and axle with an automated wheelchair assistance apparatus;

FIG. 4B is a block diagram illustrating a back view of a manual wheelchair with an automated wheelchair assistance apparatus;

FIG. 4C is a block diagram illustrating a side section view of a manual wheelchair with an automated wheelchair assistance apparatus;

FIG. 4D is a block diagram illustrating a perspective view of a manual wheelchair with an automated wheelchair assistance apparatus;

FIG. 5 is a block diagram illustrating an exemplary cloud communications network;

FIG. 6 is a block diagram illustrating an exemplary cloud storage object;

FIG. 7 is a block diagram illustrating wearable network devices used with of an automated wheelchair assistance apparatus;

FIG. 8 is a block diagram illustrating a display screen of a wheelchair application for a network device used with an automated wheelchair assistance apparatus;

FIG. 9 is a flow diagram illustrating a method for automated wheelchair assistance;

FIG. 10 is a flow diagram illustrating a method for automated wheelchair assistance;

FIGS. 11A and 11B are a flow diagram illustrating a method for automated wheelchair assistance; and

FIGS. 12A and 12B are a flow diagram illustrating a method for automated wheelchair assistance; and

FIGS. 13A and 13B are a flow diagram illustrating a method for automated wheelchair assistance; and

FIGS. 14A through 14D are a flow diagram illustrating a method for automated wheelchair assistance.

### DETAILED DESCRIPTION OF PREFERRED EMBODIMENTS

### Exemplary Automatic Wheelchair Assistance System

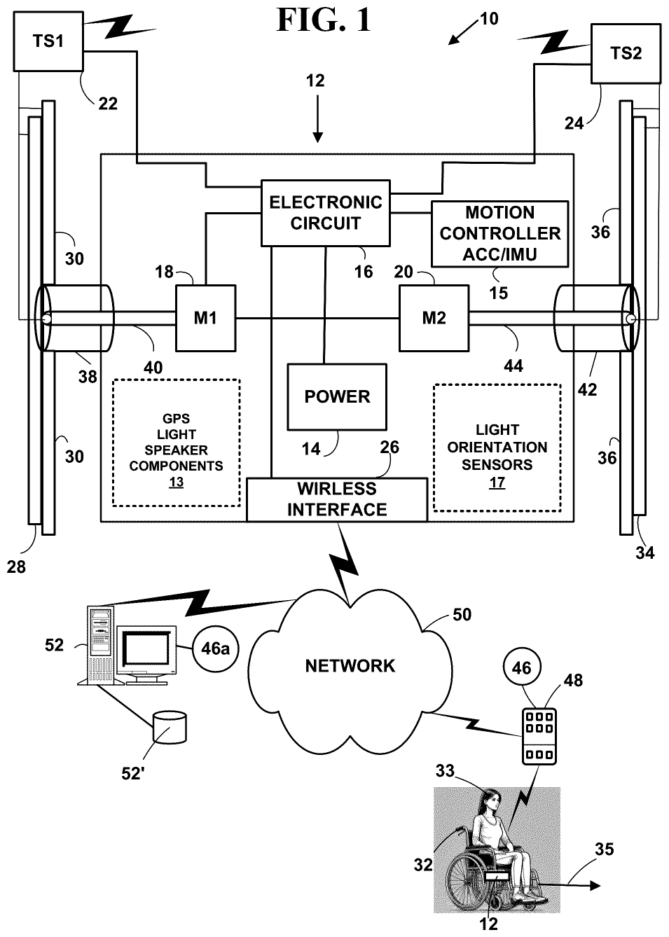

FIG. 1 is a block diagram 10 illustrating an automated wheelchair assistance apparatus 12.

The automated wheelchair assistance apparatus 12 includes, but is not limited to a power source 14, an electronic circuit 16, with one or more processors and a non-transitory computer readable medium connected to the power source 14 for controlling one or more motors 18, 20, one or more touch sensors 22, 24 a motion controller 15, and a wireless interface 26; the first touch sensor 22 for sensing a first human touch of a first outer rim 28 of a first wheelchair wheel 30 of a wheelchair 32, the first touch sensor 22 activating a first motor 18 to automatically start movement of the first wheelchair wheel 30 with a first human touch and deactivating the first motor 18 to automatically stop movement of the first wheelchair wheel 30 upon sensing of a third human touch; the second touch sensor 24 for sensing a second human touch of a second outer rim 34 of a second wheelchair wheel 36 of the wheelchair 32, the second touch sensor 24 activating a second motor 20 to automatically start movement of the second wheelchair wheel 36 with the second human touch and deactivating the second motor 20 to automatically stop movement of the second wheelchair wheel 36 upon detection of a fourth human touch; a first roller 38 connected a first shaft 40 in contact with the first wheelchair wheel 30 to rotate the first wheelchair wheel 30; a second roller 42 connected to a second shaft 44 in contact with the second wheelchair wheel 36 to rotate the second wheelchair wheel 36; the first motor 18 connected to the electronic circuit 16 and the first shaft 40 of the first roller 38 to rotate the first wheelchair wheel 30; the second motor 20 connected to the electronic circuit 16 and the second shaft 44 of second roller 42 to rotate the second wheelchair wheel 36; the first motor 18 and the second motor 20 activated together by the electronic circuit 16 for moving the wheelchair 32 in a forward direction or backward direction, or the first motor 18 and the second motor 20 activated independently by the electronic circuit 16 for moving the wheelchair 32 in plural different angular directions; the wireless interface 26 connected to the electronic circuit 16 for communicating with a wheelchair application 46 on a network device 48 with one or more processors via a communications network 50, the wheelchair application 46 on the network device 48 allowing the wheelchair 32 without a human occupant to be moved automatically with a selection input on the wheelchair application 46 on the network device 48 from a first location to a second location to be accessed by the human occupant and to a third location away from the human occupant after use; the wheelchair application 46 on the network device 48 further controlling a speed and power of the first motor 18 and the second motor 20.

In one embodiment, a speed includes, but is not limited to, a timed rate at which an object (e.g., manual wheelchair 32, etc.) is moving along a desired path. In one embodiment, the speed includes, but is not limited to, a revolutions-per-minute (RPM) value. In another embodiment, the speed is replaced with a velocity. A velocity includes, but is not limited to, a combination of a direction and a motion of an object. Speed and velocity of an object is equal when the object moves without any change in direction and/or moves in a straight-line motion.

In one embodiment, the network device 48 is in communications with a server network device 52 with one or more processors including a server wheelchair application 46a and one or more associated databases 52′ via the communications network 50. In one embodiment, the server network device 52 is a cloud server network device. However, the present invention is not limited to these embodiments and the invention can be practiced without a server network device 52.

In this embodiment, the wheelchair 32 includes a manual wheelchair 32 that does not include any electronic components. However, the present invention is not limited to such an embodiment and other embodiments can be used to practice the invention.

In one embodiment, the automated wheelchair assistance apparatus 12 further includes one or more additional components 13, including but not limited to one or more of: (1) a Global Positioning System (GPS) component; (2) a lighting component; and/or (3) a smart speaker component. However, the present invention is not limited to such an embodiment, and the automated wheelchair assistance apparatus 12 can include more, fewer and/or other additional components.

In one embodiment the motion controller 15, includes, but is not limited to, (1) an accelerometer component; and/or a (2) inertial measurement unit (IMU). However, the present invention is not limited to such an embodiment, and the motion controller 15 can include more, fewer and/or other additional components.

The accelerometer component measures accelerations, including changes in speed or direction. The accelerometer component also measures bumps and vibrations, sharp increases or decreases in velocity such as hard acceleration or braking, forces that might indicate taking a turn too fast, or a strong impact. The accelerometer data is used by the wheelchair application 46, 46a and/or an Artificial Intelligence (AI) application to determine how a wheelchair 32 is operated with the automated wheelchair assistance apparatus 12 and/or to alert emergency responders for a user 33 of the wheelchair if the wheelchair 32 is impacted by something and/or someone and/or tips over, and/or breaks down, etc. or a user 33 the manual wheelchair 32 has a health emergency, etc.

The Inertial Measurement Unit (IMU) component includes technology that uses sensors to measure acceleration, orientation, and other forces. IMUs are made up of multiple sensors, including accelerometers, gyroscopes, and magnetometers, that work together to detect movement in three dimensions: (1) Accelerometers: Measure changes in speed along an axis; (2) Gyroscopes: Sense changes in rotation and direction; (3) Magnetometers: Measure magnetic field strength to help orient the IMU with respect to the Earth's axes to determine orientation with respect to a direction on a compass.

The GPS component provides users with location, positioning, navigation, and timing (PNT) services. The GPS component records a precise physical location of the wheelchair 32. The GPS data is used by the wheelchair application 46, 46a and/or an Artificial Intelligence (AI) application to determine how a wheelchair 32 is operated (e.g., to assist in regulating speed/assistance, control of navigation, etc.) with the automated wheelchair assistance apparatus 12 and/or to alert emergency responders for a user of the wheelchair if the wheelchair 32 is impacted by something and/or someone and/or tips over, and/or breaks down, etc., or a user 33 the manual wheelchair 32 has a health emergency, etc.

The lighting component includes a halogen, incandescent and/or Light Emitting Diode (LED) light component. The lighting component allows a user 33 of the wheelchair 32 to navigate safely in a dark environment in both an inside and/or outside environment.

The smart speaker component includes a smart speaker network device that is used to send voice commands to and receive voice commands from the automated wheelchair assistance apparatus 12 via the wireless interface to control operation of the wheelchair. The smart speaker component is also used to alert emergency responders for the user 33 of the wheelchair 32 if the wheelchair 32 is impacted by something and/or someone and/or tips over and/or if the user 33 of the manual wheelchair 32 has a medical and/or health emergency, etc.

The automated wheelchair assistance apparatus 12 further includes a motion controller 15 with an accelerometer and an inertial motion unit (IMU) for detecting accelerations and decelerations and orientation motions and/or touch contact of the manual wheelchair 32. The motion controller 15 provides automatic push assistance and automatic braking assistance of the manual wheelchair 32. The motion controller 15 is sensitive enough that it takes on only very small, minor motions (e.g. a small push, pull, grab, etc.) and/or touch contacts by the user 33 of the manual wheelchair 32 to determine if the manual wheelchair is accelerating or deaccelerating. However, the present invention is not limited to such an embodiment and other embodiments can be used to practice the invention.

In one embodiment, the automated wheelchair assistance apparatus 12 further includes one or more additional sensors 17, including but not limited to one or more of: (1) an orientation sensor; and (2) a light sensor. However, the present invention is not limited to such an embodiment, and the automated wheelchair assistance apparatus 12 can include more, fewer and/or other additional sensors.

The orientation sensor measures an orientation relative to a coordinate frame. It provides information about the device's orientation in relation to a three-dimensional (3D) Cartesian coordinate system, the Earth's reference coordinate system, or other stationary or non-stationary directions. Orientation sensors often combine multiple sensors, such as accelerometers, gyroscopes, and magnetometers. The orientation sensor measures and orientation of the wheelchair 32.

The motion sensor or passive infrared (PIR) sensor is an electronic device that detects the movement of an object, anywhere within its field of view, by measuring the infrared (IR) light emitted from, or reflected by, that object, such as the wheelchair 32.

Sensor data is used by the wheelchair application 46, 46a and/or an Artificial Intelligence (AI) application to determine how a wheelchair 32 is operated (e.g., to assist in regulating speed/assistance, control of navigation, etc.) with the automated wheelchair assistance apparatus 12 and/or to alert emergency responders for a user 33 of the wheelchair if the wheelchair 32 is impacted by something and/or someone and/or tips over, and/or breaks down, etc.

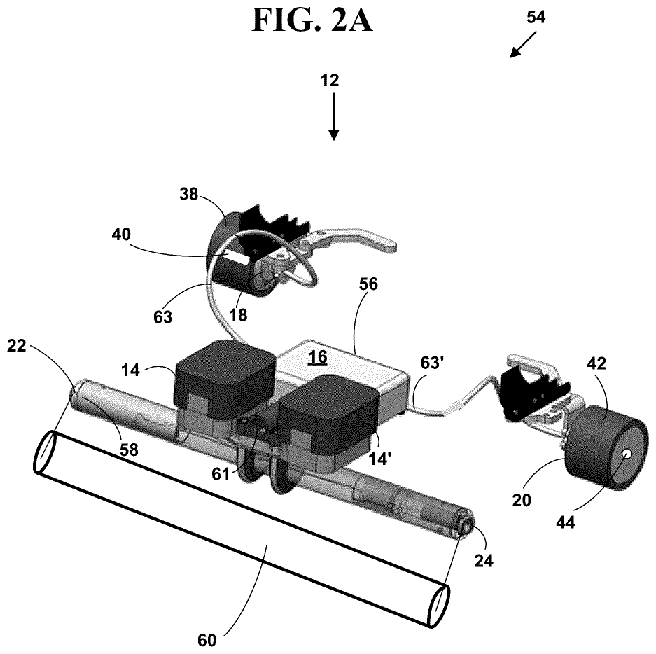

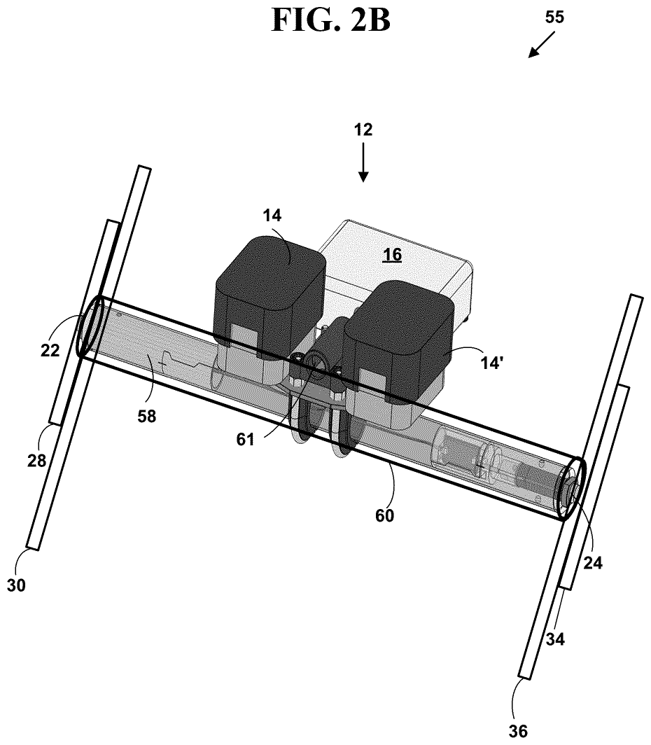

FIG. 2A is a block diagram 54 illustrating a three-dimensional (3D) perspective view of an automated wheelchair assistance apparatus 12.

In FIG. 2A, further illustrates a container component 56 for the electronic circuit 16, an electrical insulator component 58, including the first touch sensor 22 and second touch sensor 24. An electrical insulator component 58 is a material in which electric current does not flow freely. The electrical insulator component 58 is included inside a hollow metal axle 60 of the wheelchair 32 to prevent the first touch sensor 22 and the second touch sensor 24 from making electrical contact with the hollow metal axle 60 of the wheelchair 32 and thereby, unintentionally activating the electronic circuit 16 to start and stop the wheelchair 32 and allowing the first touch sensor 22 and the second touch sensor 24. FIG. 2 illustrates two batteries 14, 14′, a motor connection component 61, motor connection wires 63, 63′ and two motors 18, 20, illustrated as a motor/roller 38, 42 combination unit (e.g., a skateboard hub motorized wheel, etc.).

FIG. 2B is a block diagram 55 illustrating a three-dimensional (3D) perspective view of an automated wheelchair assistance apparatus 12.

In FIG. 2B, illustrates electrical insulator component 58 inside a metal axle 60 of wheelchair wheels 28, 30, 34, 36 for manual wheelchair 32 the first touch sensor 22 and the second touch sensor 24 are in contact with the wheelchair wheels 28, 30, 34, 36. The first touch sensor 22 and the second touch sensor 24 activated/deactivated by simply touching any the wheelchair wheels 28, 30, 34, 36 for manual wheelchair 32. The first touch sensor 22 and the second touch sensor 24 require only very light touching by a user 33 of the manual wheelchair 32 to be activated.

In one embodiment, the container component 56 for the electronic circuit 16, include a plastic, wood, rubber, metal and/or composite material, and/or a combination thereof. In one embodiment, the electrical insulator component 58 includes plastic, wood, paper, rubber, and/or types of electrical insulating materials.

A “composite material” is a combination of two materials with different physical and chemical properties. The different physical or chemical properties of the two materials remain separate and distinct at the macroscopic or microscopic scale within the finished structure. Common polymer-based composite materials, include at least two parts, a substrate (e.g., fibers, etc.) and a resin.

When they are combined, they create a material which is specialized material to do a certain job, for instance to become stronger, lighter or resistant to electricity. Composite materials also improve strength and stiffness of the materials. One reason for their use over traditional materials is because they improve the properties of their base materials and are applicable in many situations.

The composite materials include, but are not limited to, “Fiber-reinforced polymers” (FRP) including thermoplastic composites, short fiber thermoplastics, long fiber thermoplastics or long fiber-reinforced thermoplastics. There are numerous thermoset composites, but advanced systems usually incorporate aramid fiber and carbon fiber in an epoxy resin matrix. The composite materials also include carbon/carbon composite materials with carbon fibers and a silicon carbide matrix.

In one embodiment the power source 14 includes but is not limited to, a one or more rechargeable batteries and/or rechargeable capacitors, or a combination thereof, providing Direct Current (DC) power.

The one or more rechargeable battery includes, but is not limited to, a lead-acid, zinc-air, nickel-cadmium (NiCd), nickel-metal hydride (NiMH), lithium-ion (Li-ion), lithium iron phosphate (LiFePO4), and/or lithium-ion polymer (Li-ion polymer) rechargeable batteries. However, the present invention is not limited to such embodiments and other types of rechargeable batteries can be used to practice the invention.

In one embodiment, the rechargeable battery include, but are not limited to, four, eight, twelve, eighteen to twenty-four, and twenty-four to forty-eight volt, batteries. In such embodiments, the rechargeable batteries include, but are not limited to, specifically sized and shaped for power tools (e.g., saws, drills, etc.) and/or lawn care equipment (e.g., lawn mowers, blowers, weed whackers, edgers, etc.) However, the present invention is not limited to such embodiments and other types of rechargeable batteries with other voltages can be used to practice the invention.

In one embodiment, the rechargeable battery includes a wireless charger and/or a wired charger. In one embodiment, the battery charger includes a Universal Serial Bus (USB) charger. However, the present invention is not limited to such embodiments and other types of rechargeable batteries and battery chargers can be used to practice the invention.

The one or more rechargeable capacitors, include but is not limited to, a supercapacitor (SC), also called an ultracapacitor. A SC is a high-capacity capacitor, with a capacitance value much higher than solid-state capacitors but with lower voltage limits. It bridges the gap between electrolytic capacitors and rechargeable batteries. It typically stores ten to one hundred times more energy per unit volume or mass than electrolytic capacitors, can accept and deliver charge much faster than batteries, and tolerates many more charge and discharge cycles than rechargeable batteries. However, the present invention is not limited to such embodiments and other types of rechargeable capacitors can be used to practice the invention.

In one embodiment, the electronic circuit 16, includes, but is not limited to, one or more integrated circuit (IC) chips placed on one or more IC boards, with one or more processors. However, the present invention is not limited to such embodiments and other types of electronic circuits can be used to practice the invention.

An integrated circuit (IC) is an assembly of electronic components in which hundreds to millions of transistors, resistors, and capacitors are interconnected and built up on a thin substrate of semiconductor material (usually silicon) to form a small chip or wafer. An IC board is a type of printed circuit board assembly (PCBA) that includes integrated circuits (ICs) mounted on the board.

It will be appreciated that acts and symbolically represented operations or instructions include the manipulation of electrical information by a processor or Central Processing Unit (CPU). An electrical system represents data bits which cause a resulting transformation or reduction of the electrical information or biological information, and the maintenance of data bits at memory locations in a memory system to thereby reconfigure or otherwise alter the CPU's or processor's operation, as well as other processing of information. The memory locations where data bits are maintained are physical locations that have particular electrical, magnetic, optical, or organic properties corresponding to the data bits.

The data bits may also be maintained on a non-transitory computer readable medium including magnetic disks, optical disks, organic memory, and any other volatile (e.g., Random Access Memory (RAM)) or non-volatile (e.g., Read-Only Memory (ROM), flash memory, etc.) mass storage system readable by the CPU. The non-transitory computer readable medium includes cooperating or interconnected computer readable medium, which exist exclusively on the processing system or can be distributed among multiple interconnected processing systems that may be local or remote to the processing system.

In one embodiment, the first touch sensor 22 and the second touch sensor 24, further include but are not limited to, capacitive sensors, resistive sensors, acoustic wave sensors, pressure sensors, optical sensors and/or tactile touch sensors. Such sensors are sensitive to force, pressure, or touch. However, the present invention is not limited to such embodiments and other types of sensors can be used to practice the invention.

A capacitive sensor includes is a technology, based on capacitive coupling, that can detect and measure anything that is conductive or has a dielectric constant different from air.

A resistive sensor includes a transducer or electromechanical device that converts a mechanical change such as a displacement into an electrical signal that can be monitored.

An acoustic wave sensor includes wave sensors are a class of microelectromechanical systems which rely on the modulation of surface acoustic waves to sense a physical phenomenon.

A pressure sensor includes is an electronic device that detects or monitors pressure (force) and converts that information into an electrical signal that can be used to monitor or regulate the force being measured.

An optical sensor includes electronic detectors that convert light, or a change in light, into an electronic signal.

A tactile touch sensor technology of mapping and measuring the contact mechanics between two objects.

In one embodiment, the first touch sensor 22 and the second touch sensor 24, include single point and/or multiple point sensing. Single point sensing is capable of distinguishing a single point of touch, while multipoint sensing is capable of distinguishing multiple touches that occur simultaneously and/or at different times.

In one embodiment, the first touch sensor 22 and the second touch sensor 24, include touch switches are characterized by touch-based operations and open and close a respective electronic circuit simply by touching a switch. There are three primary types of touch switches, including capacitive, resistive and piezo touch switches.

Capacitive touch switches are characterized by a single electrode. The electrode is typically found behind a layer of nonconductive material, such as glass or plastic. Capacitive switches work in a similar manner as capacitive touchscreens by relying on the human body's conductive properties to open and close the circuit. When a human taps or touches the capacitive switch, its capacitance will drop, thereby triggering the switch circuit to open or close.

Resistive touch switches are characterized by the use of two electrodes. When a human taps or touches the resistive touch switch, the resistance between the electrodes decreases, thereby triggering the switch circuit to open or close.

Piezo touch switches leverage the properties of piezo ceramics to open and close an electronic circuit. They are made of piezo ceramic, which is usually found behind an exterior top layer, to support touch input from any object as well as a bare or gloved finger. When a human taps or touches the piezo touch switch, the resistance between the electrodes decreases, thereby triggering the switch circuit to open or close.

In one embodiment the first touch sensor 22 and the second touch sensor 24, are configured into for the wheelchair wheels 28, 30, 34, 36 of the manual wheelchair 32. In such embodiments, the first touch sensor 22 and the second touch sensor 24 accept touches from a human user 33 (FIG. 1) touching the outer wheels 28, 34 of the manual wheelchair 32. The data from the first touch sensor 22 and the second touch sensor 24 is sent to the wireless interfaces 26 and the motor controller 15, to initiate automatic starting and stopping of the wheelchair 32 via the first motor 18 and/or the second motor 20. However, the present invention is not limited to such embodiment and other embodiments can be used to practice the invention.

In one embodiment the first touch sensor 22 and the second touch sensor 24, are configured and/or onto different ends of an axle 60 (FIGS. 2, 3 and 4) for the wheelchair wheels 28, 30, 34, 36 of the manual wheelchair 32. In such embodiments, the first touch sensor 22 and the second touch sensor 24 accept touches from a human user 33 (FIG. 1) touching any of the wheelchair wheels 28, 30, 34, 36 of the manual wheelchair 32. In another preferred embodiment, the first touch sensor 22 and the second touch sensor 24 accept touches from a human user 33 (FIG. 1) touching only the outer wheels 28, 34 of the manual wheelchair 32. In another embodiment, the first touch sensor 22 and the second touch sensor 24 accept touches from a human user 33 (FIG. 1) touching only the inner wheels 30, 36 of the manual wheelchair 32. However, the present invention is not limited to such embodiments and other embodiments with other types of sensors can be used to practice the invention.

However, a human user 33 will typically always touch the hand rims of the wheels (outer wheels 28, 34) of the manual wheelchair 32 first. All human touches of the hand rims of the wheels 28, 34 of the manual wheelchair 32 will close and open switch circuits in the first touch sensor 22 and the second touch sensor 24 to initiate automatic movement of the wheelchair 32 via the first motor 18 and/or the second motor 20. The first touch sensor 22 and the second touch sensor 24 require only small, minimal touches to initiate automatic starting and stopping of the wheelchair 32 via the first motor 18 and/or the second motor 20. However, the present invention is not limited to such and embodiment and other embodiments can be used to practice the invention.

In one embodiment, the first touch sensor 22 and the second touch sensor 24, include but are not limited to, capacitive touch sensors. Capacitive touch sensors are used with an open/closed switch to activate a motor 18, 20. A code is generated based on the reading of the sensor, if a touch of human user 33 is detected. A capacitive touch sensor is not actually a capacitor, but instead uses measurement of the charge like a capacitor to discharge time of the conductive material and that is what is used to determine if there was a touch instance. However, the present invention is not limited to such embodiments and other types of switches can be used to practice the invention.

In one embodiment, the first touch sensor 22 includes a first wireless sensor detecting any motions and/or touch contacts of the first wheelchair wheels 28, 30 and the second touch sensor includes a second wireless sensor detecting any motions and/or touch contacts of the second wheelchair wheels 34, 36.

In one embodiment, the first touch sensor 22 includes a first sensor connected with a wire to one or more of the first wheelchair wheels 28, 30 and the second touch sensor includes a second wired sensor connected to one or more of the second wheelchair wheels 34, 36, detecting any motions and/or touch contacts of the second wheel chair wheels 34, 36.

However, the present invention is not limited to such embodiments and other types of touch sensors can be used to practice the invention.

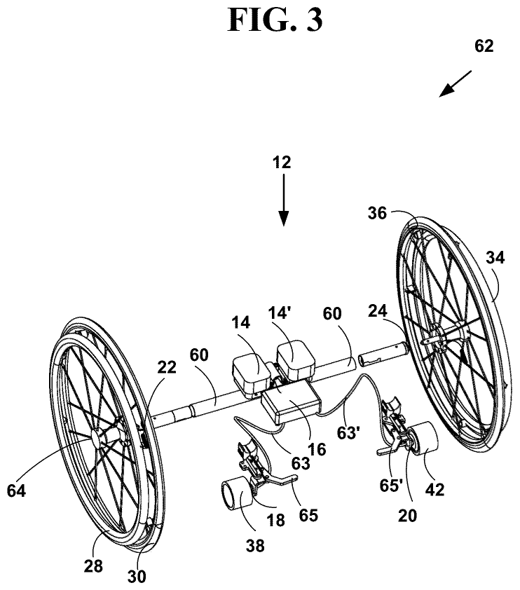

FIG. 3 is a block diagram 62 illustrating a perspective view of manual wheelchair wheels and axle and an automated wheelchair assistance apparatus 12.

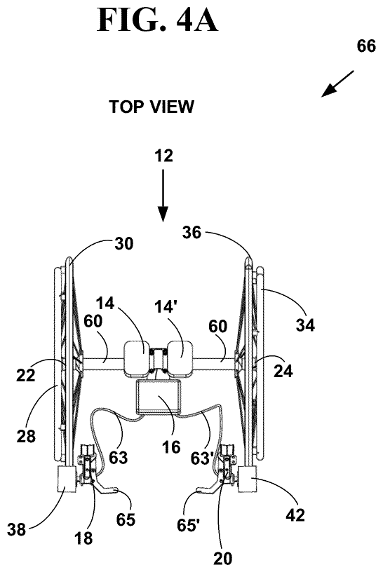

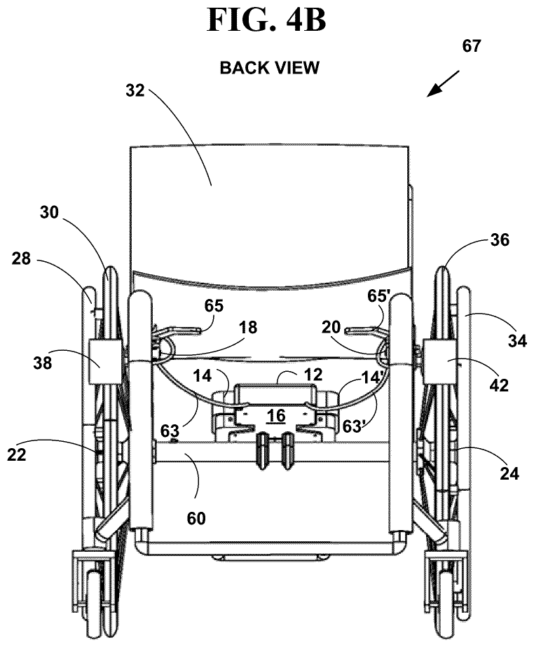

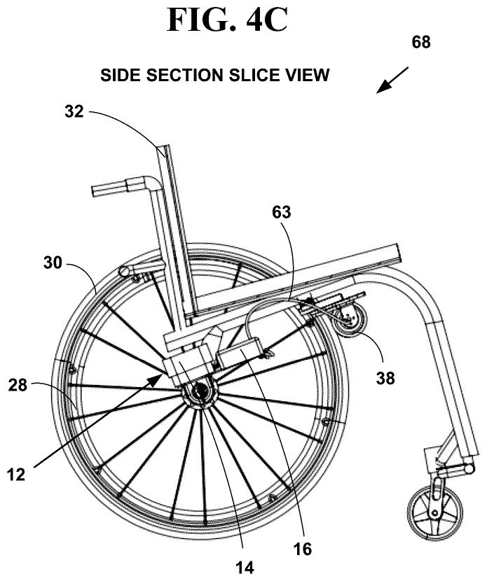

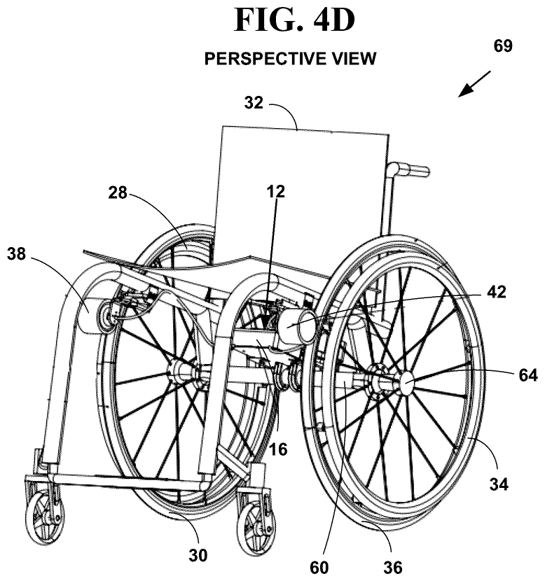

FIG. 4A is a block diagram 66 illustrating a top view of manual wheelchair wheels and axle with an automated wheelchair assistance apparatus 12.

FIG. 4B is a block diagram 67 illustrating a back view of a manual wheelchair 32 with an automated wheelchair assistance apparatus 12.

FIG. 4C is a block diagram 68 illustrating a side section slice view of a manual wheelchair 32 with an automated wheelchair assistance apparatus 12.

FIG. 4C includes only one set of wheelchair wheels 28, 30 and includes a slice through a middle line of the manual wheelchair 32.

FIG. 4D is a block diagram 69 illustrating a perspective view of a manual wheelchair 32 with an automated wheelchair assistance apparatus 12.

In FIG. 3, in one embodiment, components of the automated wheelchair assistance apparatus 12 are mounted within (see FIGS. 2A and 2B) an axle 60 of the wheelchair 32 operating underneath a seat portion of the wheelchair 32. FIG. 3 illustrates the automated wheelchair assistance apparatus 12 and only the axle 60, axle hub 64 and the wheelchair wheels, 28, 30, 34, 36 of the wheelchair 32. The first touch sensor 18 is placed to make contact with an inner surface of the first metal and/or non-metal outer rim 28 of the first wheelchair wheel 30 from within the axle 60 of the wheelchair wheels, 28, 30, 34, 36. However, the present invention is not limited to this embodiment and the first touch sensor 18 can be connected to other parts of the wheelchair 32. The second touch sensor 24 is placed to make contact with an inner surface of the first metal and/or non-metal second outer rim 34 of the second wheelchair wheel 36 from within the axle 60 of the wheelchair wheels, 28, 30, 34, 36. However, the present invention is not limited to this embodiment and the second touch sensor 24 can be connected to other parts of the wheelchair 32.

FIG. 3 also illustrates a power wire 63, 63′ to connect the first motor 18 and the second motor 20 to the electronic circuit 16 and the power source 14, 14′ and a motor connection comment 65, 65′ to connect the first motor 18 and the second motor 20 to the wheelchair 32. FIG. 3 illustrates the first motor 18 and the second motor 20 as skate board motors as described herein. A skate board motor includes a combination of a motor and a roller as one component. However, the present invention is not limited to a skateboard motor and other types of motors can be used to practice the invention.

In FIG. 3, the first touch sensor 22 is activated and a first touch sensor circuit is closed when a human occupant starts touching a first metal outer rim 28 of the first wheelchair wheel 30 activating (i.e., turning the power 14 on via the electronic circuit 16 for) the first motor 18 and/or the second touch sensor 24 is activated and a second touch sensor circuit is closed when the human occupant starts touching a second metal outer rim 34 of the second wheelchair wheel 36 activating the second motor 20.

In another embodiment, the first touch sensor 22 is activated and a first touch sensor circuit is closed when a human occupant starts touching a first non-metal wheelchair wheel 30 activating the first motor 18 and/or the second touch sensor 24 is activated and a second touch sensor circuit is closed when the human occupant starts touching a second non-metal wheelchair wheel 36 activating the second motor 20. However, the present invention is not limited to such embodiments and other embodiments can be used to practice the invention.

In another embodiment, the first touch sensor 22 detects any motions and/or touch contacts of a second inner rim of the first wheelchair wheel 30 and the second touch sensor 24 detects motions and/or touch contacts of a second inner rim of the second wheelchair wheel 36. However, the present invention is not limited to such embodiments and other embodiments can be used to practice the invention.

In one embodiment, the first touch sensor 22 is activated with a first touch including a first small forward push motion and the second touch sensor 24 is activated with a second small forward push motion. The first forward push motion and the second forward push motion are typically done simultaneously (e.g. to move the wheelchair 32 in a forward and/or backward, direction, etc.) However, the first forward push motion and the second forward push motion can be done independently (e.g., to move the wheelchair 32, right, left and/or at a desired angle direction, etc.).

In one embodiment, the first touch sensor circuit and the second touch sensor circuit are provided by a selected touch sensor switch and starting and stopping of the human touching triggers the first and second touch sensor circuit to open or close.

The first touch sensor 22 is deactivated and the first touch sensor circuit is opened when a human occupant again touches the first metal outer rim 28 of the first wheelchair wheel 30 deactivating the first motor 18 and/or the second touch sensor 24 is deactivated and the second touch sensor circuit is opened when the human again touches the second metal outer rim 34 of the second wheelchair wheel 36 deactivating the second motor 20.

In another embodiment, the first touch sensor 22 including a first touch switch is placed on a right side and the second touch sensor 24 including a second touch switch are placed on the sides of the wheelchair seat and/or on the arm rests of the wheelchair seat of the wheelchair 32. However, the present invention is not limited to such an embodiment and other embodiments can be used to practice the invention.

The automated wheelchair assistance apparatus 12 is integrated onto a manual wheelchair 32 in such a way, that when the power 14 is turned off on the automated wheelchair assistance apparatus 12 does not change how a manual wheelchair is operated by a user 33 including, but not limited to, pushing, braking, turning, sitting idle, etc.

The automated wheelchair assistance apparatus 12 is integrated onto a manual wheelchair 32 in such a way, that the automated wheelchair assistance apparatus 12 does not change how a manual wheelchair is operated by a user 33 including, but not limited to, manual pushing, braking, turning, sitting idle, etc. before and after automatic pushing assistance and automatic braking assistance is turned on and off with a simple touch of the wheels 28, 34 of the manual wheelchair 32.

A DC motor assist is activated and deactivated through sensing the user's 33 touch (e.g., touch, forward push, etc.) of a standard wheelchair wheel hand rim 28, 34 (i.e., outer wheel, etc.). This touch sensing interaction allows for seamless use of the manual wheelchair 32 in the same way as without motor assistance. Once one or more of the first touch and/or the second touch are detected the electronic circuit 16 of the apparatus 12 will sense a speed of the wheelchair 32 wheels 30, 26 and initiate the first motor 18 and second motor 20 to continue at that speed until one or more of the third touch and the fourth touch instance is detected. This eliminates repetitive pushing by a user 33 of the wheels of manual wheelchair 32 that is typically required when a manual wheelchair 32 is used. When one or more of the third touch and/or fourth touch are detected on one or more the wheelchair 32 wheels 30, 26 the electronic circuit 16 of the apparatus 12 deactivates first motor 18 and/or second motor 18 to slow, stop and/or apply a brake to the wheels of the wheelchair 32. During a touch instance the apparatus 12 will also provide an assigned level of assistance if the wheel 30, 36 is accelerating (i.e., pushing the wheel, etc.) or no assistance if the wheel 30, 36 is not accelerating (i.e., slowing down the wheel/braking or sitting idle, etc.).

The first motor 18 and the second motor 20 include but are not limited to, brushed, steeper and brushless, direct current (DC) motors. However, the present invention is not limited to such embodiments and other types of motors can be used to practice the invention.

A brushed DC motor, is an electric motor designed to be run from a DC power source and utilizing electric brushes for electrical contact. An electrical brush or carbon brush is the electrical contact, often made from specially prepared carbon, which conducts current between stationary and rotating parts. The low cost of these motors makes them suitable for many uses including on wheelchairs 32. One drawback, however, is that brushes and commutators tend to wear relatively quickly as a result of their continued contact, requiring frequent replacement and periodic maintenance.

A stepper motor, is driven by pulses. A steeper motor rotates through a specific angle (i.e., a step) with each pulse. Because the rotation is precisely controlled by a number of pulses received, these motors are widely used to implement positional adjustments. They are often used, for example, to control machines in fixed steps, which are easily correlated with pulse count. Pausing can also be easily controlled, as motor rotation stops instantly when the pulse signal is interrupted.

A brushless DC motor, is a synchronous motor using DC electric power supply. It uses an electronic controller to switch DC currents between plural motor windings producing magnetic fields that effectively rotate in space and which a permanent magnet rotor follows. The controller adjusts the phase and amplitude of the current pulses that control the speed and torque of the motor. It is an improvement on the mechanical brushes used in many conventional brushed DC motors.

In one embodiment, the first motor 18 and the second motor 20 includes DC motors weighing about one to four pounds (0.45 kilograms (kg) to about 0.9 kg) and with a Power Range of about 7.5 Watts (W) to about 985 W and a Torque Range to about 0.3 Newton-meters (Nm) to about 250 Nm. However, the present invention is not limited to such an embodiment and other types of DC motors can be used to practice the invention.

In one embodiment, the first motor 18 and the second motor 20 includes a DC skateboard hub brushless motor (FIGS. 2-4) including a motor 18, 20 and a roller 38, 42 in a single unit. In such an embodiment, a DC skateboard hub wheel includes, but is not limited to, a 70-millimeter (mm) 150 W, 24V/36V brushless and/or bushed hub motor Polyurethane (PU) wheel including integral shafts 42, 44. However, the present invention is not limited to such an embodiment and other types of DC motors can be used to practice the invention.

In another embodiment, the first motor 18 and the second motor 20 include separate rollers 38, 42. The first roller 38 and the second roller 42 include, but are not limited to, solid rollers comprising, rubber, plastic, metal, wood, composite material and/or other types of solid rollers and/or a combination thereof.

The first shaft 40 and the second shaft 44 include, metal, plastic and/or composite material shafts and/or a combination thereof. However, the present invention is not limited to such embodiments and other types of rollers and shafts made of other materials can be used to practice the invention.

The solid rollers 38, 42 include smooth surface rollers with roller diameters ranging from about one inch (about 2.54 centimeter (cm)) to about four inches (about 10.1 cm) and also include: roller only, bearing mount rollers, threaded stud mount rollers, and shaft mount rollers, with and/or without ball bearings and/or a combination thereof.

The motion controller 15 with an accelerometer includes sensing acceleration and deacceleration of the manual wheelchair 32 providing automatic push assistance and automatic braking assistance.

The wireless interface 26, includes but is not limited to, an IEEE 802.11a, 802.11b, 802.11g, 802.11n, 802.15.4 (ZigBee), “Wireless Fidelity” (Wi-Fi), “Worldwide Interoperability for Microwave Access” (WiMAX), ETSI High Performance Radio Metropolitan Area Network (HIPERMAN), “RF Home”, BLUETOOTH (IEEE 802.15.1), Infra Data Association (IrDA), Radio Frequency Identifier (RFID), Near Field Communications (NFC), Machine-to-Machine (M2M), smart speaker, and/or Internet of Things (IoT), wireless interfaces. However, the present invention is not limited to such embodiments and other types of rechargeable capacitors can be used to practice the invention.

802.11b is a short-range wireless network standard. The IEEE 802.11b standard defines wireless interfaces that provide up to 11 Mbps wireless data transmission to and from wireless devices over short ranges. 802.11a is an extension of the 802.11b and can deliver speeds up to 54 Mbps. 802.11g deliver speeds on par with 802.11a. However, other 802.11XX interfaces can also be used and the present invention is not limited to the 802.11 protocols defined. The IEEE 802.11a, 802.11b and 802.11g standards are incorporated herein by reference.

Wi-Fi is a type of 802.11xx interface, whether 802.11b, 802.11a, dual-band, etc. Wi-Fi devices include an RF-interfaces such as 2.4 GHz for 802.11b or 802.11g and 5 GHz for 802.11a.

802.15.4 (Zigbee) is low data rate network standard used for mesh network devices such as sensors, interactive toys, smart badges, remote controls, and home automation. The 802.15.4 standard provides data rates of 250 kbps, 40 kbps, and 20 kbps., two addressing modes; 16-bit short and 64-bit IEEE addressing, support for critical latency devices, such as joysticks, Carrier Sense Multiple Access/Collision Avoidance, (CSMA-CA) channel access, automatic network establishment by a coordinator, a full handshake protocol for transfer reliability, power management to ensure low power consumption for multi-month to multi-year battery usage and up to 16 channels in the 2.4 GHz Industrial, Scientific and Medical (ISM) band (Worldwide), 10 channels in the 915 MHz (US) and one channel in the 868 MHz band (Europe). The IEEE 802.15.4-2003 standard is incorporated herein by reference.

WiMAX is an industry trade organization formed by leading communications component and equipment companies to promote and certify compatibility and interoperability of broadband wireless access equipment that conforms to the IEEE 802.16XX and ETSI HIPERMAN. HIPERMAN is the European standard for metropolitan area networks (MAN).

The IEEE The 802.16a and 802.16g standards are wireless MAN technology standard that provides a wireless alternative to cable, DSL and T1/E1 for last mile broadband access. It is also used as complimentary technology to connect IEEE 802.11XX hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. WiMAX can be used to provide a WLP.

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. ETSI HIPERMAN can be used to provide a WLP.

BLUETOOTH (IEEE 802.15.1), is a short-range wireless technology standard that is used for exchanging data between fixed and mobile devices over short distances and building wireless personal area networks (WPANs). In the most widely used mode, transmission power is limited to 2.5 milliwatts, giving it a very short range of up to ten meters (about 33 ft). It employs UHF radio waves in the ISM bands, from 2.402 GHz to 2.48 GHz.

Infrared data association (IrDA) is a kind of wireless optical communication interface that provides physically secure data transfer, line-of-sight (LOS) and very low bit error rate (BER) data transfer.

Radio-Frequency Identification (RFID) uses electromagnetic fields to automatically identify and track tags attached to objects. An RFID system consists of a tiny radio transponder called a tag, a radio receiver, and a transmitter. When triggered by an electromagnetic interrogation pulse from a nearby RFID reader device, the tag transmits digital data, usually an identifying number, back to the reader. An “RFID tag” is an object that can be applied to or incorporated into a product, animal, or person for the purpose of identification and/or tracking using RF signals. An “RFID sensor” is a device that measures a physical quantity and converts it into an RF signal which can be read by an observer or by an instrument or a network device (e.g., target network devices 48, server network devices 52, etc.)

“Near field communication (NFC)” is a set of standards for smartphones and similar network devices to establish radio communication with each other by touching them together or bringing them into close proximity, usually no more than a few centimeters. Present applications include contactless transactions, data exchange, and simplified setup of more complex communications such as Wi-Fi. Communication is also possible between an NFC device and an unpowered NFC chip, called a “tag” including radio frequency identifier (RFID) tags 99 and/or sensor.

NFC standards cover communications protocols and data exchange formats, and are based on existing radio-frequency identification (RFID) standards including ISO/IEC 14443 and FeliCa. These standards include ISO/IEC 1809 and those defined by the NFC Forum, all of which are incorporated by reference.

“Machine to machine (M2M)” refers to technologies that allow both wireless and wired systems to communicate with other devices of the same ability. M2M uses a device to capture an event (such as option purchase, etc.), which is relayed through a network (wireless, wired cloud, etc.) to an application (software program), that translates the captured event into meaningful information. Such communication was originally accomplished by having a remote network of machines relay information back to a central hub for analysis, which would then be rerouted into a system like a personal computer.

However, modern M2M communication has expanded beyond a one-to-one connection and changed into a system of networks that transmits data many-to-one and many-to-many to plural different types of devices and appliances. The expansion of IP networks across the world has made it far easier for M2M communication to take place and has lessened the amount of power and time necessary for information to be communicated between machines.

A “smart speaker” is a type of wireless speaker interface and voice command device interface with an integrated virtual assistant that offers interactive actions and hands-free activation with the help of one “hot word” (or several “hot words”). Some smart speakers can also act as a smart device that utilizes Wi-Fi, BLUETOOTH and other wireless protocol standards to extend usage beyond audio playback, such as to control home automation devices. This can include, but is not be limited to, features such as compatibility across a number of services and platforms, peer-to-peer connection through mesh networking, virtual assistants, and others. Each can have its own designated interface and features in-house, usually launched or controlled via application or home automation software. Some smart speakers also include a screen to show the user a visual response. A smart speaker is a network device that combines the capabilities of a virtual assistant with a traditional speaker. It uses Artificial Intelligence (AI) and natural language processing to respond to voice commands and perform tasks. Smart speakers are usually Wi-Fi enabled and come with built-in voice assistants like GOOGLE ASSISTANT, AMAZON ALEXA, or APPLE SIRI.

Internet of Things (IoT) wireless interfaces, include but are not limited to, wireless interfaces from security cameras, doorbells with real-time video cameras, baby monitors, televisions, set-top boxes, lighting, heating (e.g., smart thermostats, etc.), ventilation, air conditioning (HVAC) systems, and appliances such as washers, dryers, robotic vacuums, air purifiers, ovens, refrigerators, freezers, toys, game platform controllers, game platform attachments (e.g., googles, sports equipment, etc.), and/or other types of IoT network devices.

In one embodiment, of the invention, the wireless interfaces 26 also include wireless personal area network (WPAN) interfaces. As is known in the art, a WPAN is a personal area network for interconnecting devices centered around an individual person's devices in which the connections are wireless. A WPAN interconnects all the ordinary computing and communicating devices that a person has on their desk (e.g. computer, etc.) or carry with them (e.g., PDA, mobile phone, smart phone, tablet computer, etc.).

A key concept in WPAN technology is known as “plugging in.” In the ideal scenario, when any two WPAN-equipped devices come into close proximity (within several meters and/or feet of each other) or within a few miles and/or kilometers of a central server (not illustrated), they can communicate via wireless communications as if connected by a cable. WPAN devices can also lock out other devices selectively, preventing needless interference or unauthorized access to secure information. Zigbee is one wireless protocol used on WPAN networks such as cloud communications network 50 or non-cloud communications network 50′.

However, the present invention is not limited to such wireless interfaces 26 and wireless networks and more, fewer and/or other wireless interfaces 26 can be used to practice the invention.

The network device 48 includes, but is not limited to: desktop computers, laptop computers, tablet computers, mobile phones, non-mobile phones, smart phones, personal digital/data assistants (PDA), portable game consoles, non-portable game consoles, wearable network devices, Internet of Things (IoT) devices, cable television (CATV) set-top boxes, satellite television boxes, and/or digital televisions, including high-definition (HDTV) and three-dimensional (3D) televisions.

### Cloud Computing Networks

FIG. 4 is a block diagram 70 illustrating an exemplary cloud computing network 50. The cloud computing network 50 is also referred to as a “cloud communications network” 50. However, the present invention is not limited to this cloud computing model and other cloud computing models can also be used to practice the invention. The exemplary cloud communications network includes both wired and/or wireless components of public and private networks.

In one embodiment, the cloud computing network 50 includes a cloud communications network 50 comprising plural different cloud component networks 72, 74, 76, 78. “Cloud computing” is a model for enabling, on-demand network access to a shared pool of configurable computing resources (e.g., public and private networks, servers, storage, applications, and services) that are shared, rapidly provisioned and released with minimal management effort or service provider interaction.

This exemplary cloud computing model for electronic information retrieval promotes availability for shared resources and comprises: (1) cloud computing essential characteristics; (2) cloud computing service models; and (3) cloud computing deployment models. However, the present invention is not limited to this cloud computing model and other cloud computing models can also be used to practice the invention.

Exemplary cloud computing essential characteristics appear in Table 1. However, the present invention is not limited to these essential characteristics and more, fewer or other characteristics can also be used to practice the invention.

TABLE 1
1. On-demand automated wheelchair assistance services. Automated
wheelchair assistance services can unilaterally provision computing
capabilities, such as server time and network storage, as needed
automatically without requiring human interaction with each network
server on the cloud communications network 50.
2. Broadband network access. Automated wheelchair assistance capabilities
are available over plural broadband communications networks and
accessed through standard mechanisms that promote use by
heterogeneous thin or thick client platform network devices 48 (e.g.,
mobile phones, smart phones, tablet computers, laptops, PDAs, etc.).
The broadband network access includes high speed network access such
as 3 G, 4 G and 5 G wireless and/or wired and broadband and/or ultra-
broad band (e.g., WiMAX, etc.) network access.
3. Resource pooling. Automated wheelchair assistance resources are pooled
to serve multiple requesters using a multi-tenant model, with different
physical and virtual resources dynamically assigned and reassigned
according to demand. There is location independence in that a requester
of services has no control and/or knowledge over the exact location of
the provided by the automated wheelchair assistance services,
interoperability service resources but may be able to specify location at
a higher level of abstraction (e.g., country, state, or data center).
Examples of pooled resources include storage, processing, memory,
network bandwidth, virtual server network device and virtual target
network devices.
4. Rapid elasticity. Capabilities can be rapidly and elastically provisioned,
in some cases automatically, to quickly scale out and rapidly released to
quickly scale for automated wheelchair assistance services
collaboration. For automated wheelchair assistance services, multi-
media collaboration converters, the automated wheelchair assistance
services collaboration and analytic conversion capabilities available for
provisioning appear to be unlimited and can be used in any quantity at
any time.
5. Measured Services. Cloud computing systems automatically control and
optimize resource use by leveraging a metering capability at some level
of abstraction appropriate to the type of automated wheelchair
assistance services (e.g., storage, processing, bandwidth, custom
electronic content retrieval applications, etc.). Electronic automated
wheelchair assistance services collaboration conversion usage is
monitored, controlled, and reported providing transparency for both the
automated wheelchair assistance services provider and the automated
wheelchair assistance services, requester of the utilized electronic
content storage retrieval service.

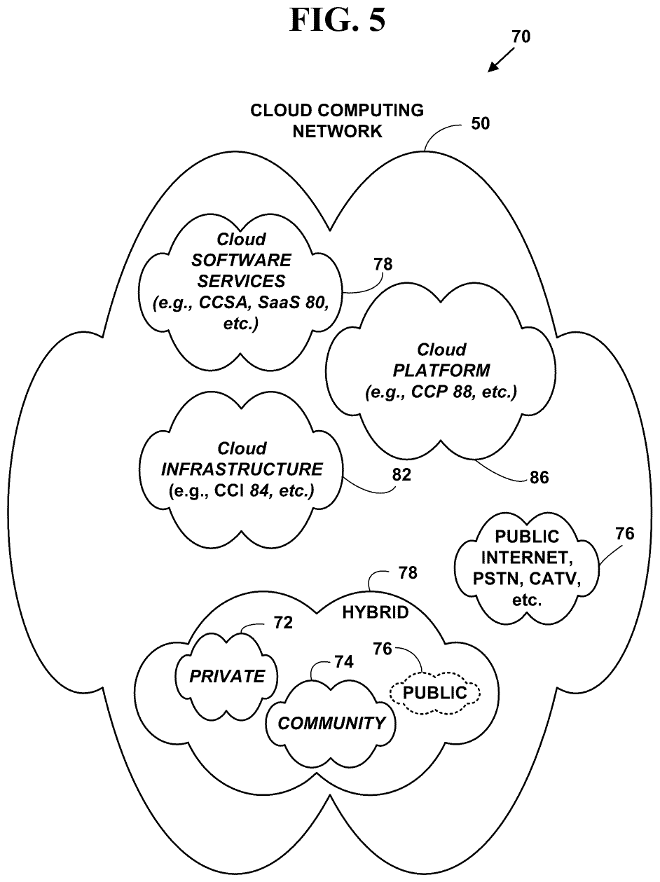

Exemplary cloud computing service models illustrated in FIG. 5 appear in Table 2. However, the present invention is not limited to these service models and more, fewer or other service models can also be used to practice the invention.

TABLE 2
1. Cloud Computing Software Applications 78 for automated wheelchair
assistance services (CCSA, SaaS 80). The capability to use the
provider's applications 46, 46a running on a cloud infrastructure 82.
The cloud computing applications 78, are accessible from the server
network device 52 from various client devices 48 through a thin client
interface such as a web browser, etc. The user does not manage or
control the underlying cloud infrastructure 66 including network,
servers, operating systems, storage, or even individual application 46,
46a capabilities, with the possible exception of limited user-specific
application configuration settings.
2. Cloud Computing Infrastructure 82 for automated wheelchair assistance
services (CCI 84). The capability provided to the user is to provision
processing, storage and retrieval, networks 50, 50′ and other
fundamental computing resources where the consumer is able to deploy
and run arbitrary software, which can include operating systems and
applications 48, 48a. The user does not manage or control the
underlying cloud infrastructure 82 but has control over operating
systems, storage, deployed applications, and possibly limited control of
select networking components (e.g., host firewalls, etc.).
3. Cloud Computing Platform 86 for automated wheelchair assistance
services (CCP 88). The capability provided to the user to deploy onto
the cloud infrastructure 82 created or acquired applications created
using programming languages and tools supported servers 54, etc. The
user not manage or control the underlying cloud infrastructure 66
including network, servers, operating systems, or storage, but has
control over the deployed applications 46, 46a and possibly application
hosting environment configurations.

Exemplary cloud computing deployment models appear in Table 3. However, the present invention is not limited to these deployment models and more, fewer or other deployment models can also be used to practice the invention.

TABLE 3
1. Private cloud network 72. The cloud network infrastructure 82 is
operated solely for automated wheelchair assistance services. It may
be managed by the electronic content retrieval or a third party and
may exist on premise or off premise.
2. Community cloud network 74. The cloud network infrastructure 82
is shared by several different organizations and supports a specific
electronic content storage and retrieval community that has shared
concerns (e.g., mission, security requirements, policy, compliance
considerations, etc.). It may be managed by the different organizations
or a third party and may exist on premise or off premise.
3. Public cloud network 76. The cloud network infrastructure 82 such as
the Internet, PSTN, SATV, CATV, Internet TV, etc. is made available
to the general public or a large industry group and is owned by one or
more organizations selling automated wheelchair assistance cloud
services.
4. Hybrid cloud network 78. The cloud network infrastructure 66 is a
composition of two and/or more cloud networks 50 (e.g., private 72,
community 74, and/or public 76, etc.) and/or other types of public
and/or private networks (e.g., intranets, etc.) that remain unique entities
but are bound together by standardized or proprietary technology that
enables data and application portability (e.g., cloud bursting for load-
balancing between clouds, etc.)

Cloud software 80 for electronic content retrieval takes full advantage of the cloud paradigm by being service oriented with a focus on statelessness, low coupling, modularity, and semantic interoperability for electronic content retrieval. However, cloud software services 64 can include various states.

Cloud storage of desired electronic content on a cloud computing network includes agility, scalability, elasticity and multi-tenancy. Although a storage foundation may be comprised of block storage or file storage such as that exists on conventional networks, cloud storage is typically exposed to requesters of desired electronic content as cloud objects.

In one exemplary embodiment, the cloud application 46, 46a offers cloud services for automated wheelchair assistance. The application 46, 46a offers the cloud computing Infrastructure 82, 84 as a Service 84 (IaaS), including a cloud software infrastructure service 84, the cloud Platform 86, 88 as a Service 88 (PaaS) including a cloud software platform service 88 and/or offers Specific cloud software services as a Service 78 (SaaS) including a specific cloud software service 80 for automated wheelchair assistance services. The IaaS, PaaS and SaaS include one or more of cloud services comprising networking, storage, server network device, virtualization, operating system, middleware, run-time, data and/or application services, or plural combinations thereof, on the cloud communications network 50.

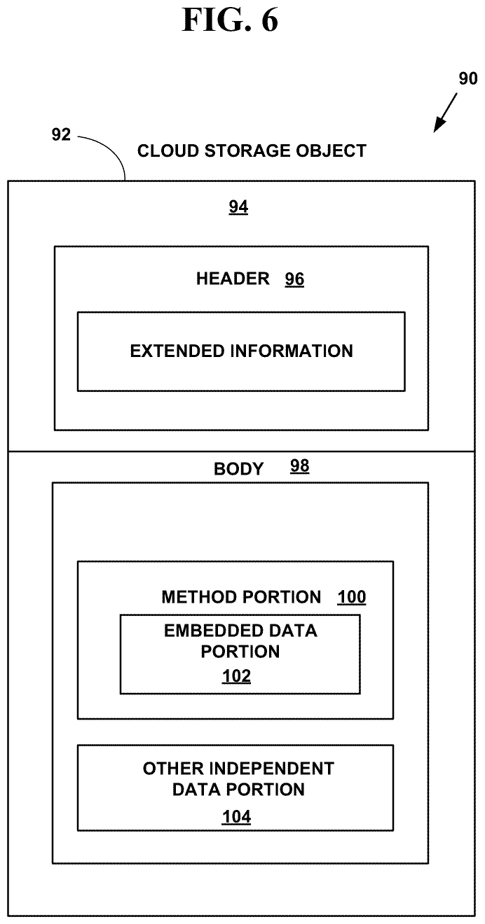

FIG. 6 is a block diagram 90 illustrating an exemplary cloud storage object 92. One or more server network devices (e.g., 54, etc.) store portions of automatic automated electronic message content as cloud storage objects 92 (FIG. 6) as is described herein.

The cloud storage object 92 includes an envelope portion 94, with a header portion 96, and a body portion 98. However, the present invention is not limited to such a cloud storage object 92 and other cloud storage objects and other cloud storage objects with more, fewer or other portions can also be used to practice the invention.

The envelope portion 984 uses unique namespace Uniform Resource Identifiers (URIs) and/or Uniform Resource Names (URNs), and/or Uniform Resource Locators (URLs) unique across the cloud communications network 50 to uniquely specify, location and version information and encoding rules used by the cloud storage object 92 across the whole cloud communications network 50. For more information, see IETF RFC-3305, Uniform Resource Identifiers (URIs), URLs, and Uniform Resource Names (URNs), the contents of which are incorporated by reference.

The envelope portion 94 of the cloud storage object 92 is followed by a header portion 96. The header portion 96 includes extended information about the cloud storage objects such as authorization and/or transaction information, etc.

The body portion 98 includes methods 100 (i.e., a sequence of instructions, etc.) for using embedded application-specific data in data elements 102. The body portion 98 typically includes only one portion of plural portions of application-specific data 102 and independent data 104 so the cloud storage object 92 can provide distributed, redundant fault tolerant, security and privacy features described herein.

Cloud storage objects 92 have proven experimentally to be a highly scalable, available and reliable layer of abstraction that also minimizes the limitations of common file systems. Cloud storage objects 92 also provide low latency and low storage and transmission costs.

Cloud storage objects 92 are comprised of many distributed resources, but function as a single storage object, are highly fault tolerant through redundancy and provide distribution of desired electronic content across public communication networks 76, and one or more private networks 72, community networks 74 and hybrid networks 78 of the cloud communications network 50. Cloud storage objects 92 are also highly durable because of creation of copies of portions of desired electronic content across such networks 72, 74, 76, 78 of the cloud communications network 50. Cloud storage objects 92 includes one or more portions of desired electronic content and can be stored on any of the 72, 74, 76, 78 networks of the cloud communications network 50. Cloud storage objects 92 are transparent to a requester of desired electronic content and are managed by cloud applications 46, 46a.

In one embodiment, cloud storage objects 92 are configurable arbitrary objects with a size up to hundreds of terabytes, each accompanied by with a few kilobytes of metadata. Cloud objects are organized into and identified by a unique identifier unique across the whole cloud communications network 50. However, the present invention is not limited to the cloud storage objects described, and more fewer and other types of cloud storage objects can be used to practice the invention.

Cloud storage objects 92 present a single unified namespace or object-space and manages desired electronic content by user or administrator-defined policies storage and retrieval policies. Cloud storage objects include one or more of Representational state transfer (REST), Simple Object Access Protocol (SOAP), Lightweight Directory Access Protocol (LDAP) and/or Application Programming Interface (API) objects and/or other types of cloud storage objects 92. However, the present invention is not limited to the cloud storage objects described, and more fewer and other types of cloud storage objects can be used to practice the invention.

REST is a protocol specification that characterizes and constrains macro-interactions storage objects of the four components of a cloud communications network 50, namely origin servers, gateways, proxies and clients, without imposing limitations on the individual participants.

SOAP is a protocol specification for exchanging structured information in the implementation of cloud services with storage objects. SOAP has at least three major characteristics: (1) Extensibility (including security/encryption, routing, etc.); (2) Neutrality (SOAP can be used over any transport protocol such as HTTP, SMTP or even TCP, etc.), and (3) Independence (SOAP allows for almost any programming model to be used, etc.)

LDAP is a software protocol for enabling storage and retrieval of electronic content and other resources such as files and devices on the cloud communications network 50. LDAP is a “lightweight” version of Directory Access Protocol (DAP), which is part of X.500, a standard for directory services in a network. LDAP may be used with X.509 security and other security methods for secure storage and retrieval. X.509 is public key digital certificate standard developed as part of the X.500 directory specification. X.509 is used for secure management and distribution of digitally signed certificates across networks.

An API is a particular set of rules and specifications that software programs can follow to communicate with each other. It serves as an interface between different software programs and facilitates their interaction and provides access to automatic capital management with automated wheelchair assistance services in a cloud 50 or non-cloud 50′ environment. In one embodiment, the API for automated wheelchair assistance services is available to network devices 48, 106-112 and networks 50, 50′. However, the present invention is not limited to such an embodiment and other embodiments can be used to practice the invention.

### Wearable Devices

Wearable technology” and/or “wearable devices” are clothing and accessories incorporating computer and advanced electronic technologies. Wearable network devices provide several advantages including, but not limited to: (1) Quicker access to notifications. Important and/or summary notifications are sent to alert a user to view the whole message. (2) Heads-up information. Digital eye wear allows users to display relevant information like directions without having to constantly glance down; (3) Always-on Searches. Wearable devices provide always-on, hands-free searches; and (4) Recorded data and feedback. Wearable devices take telemetric data recordings and providing useful feedback for users for exercise, health, fitness, etc. activities.

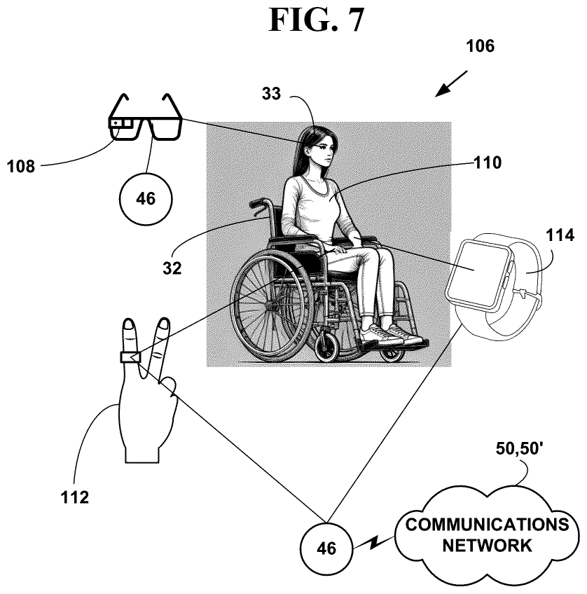

FIG. 7 is a block diagram with 106 illustrating wearable devices used with an automated wheelchair assistance apparatus 12.

In one embodiment, the wheelchair user 33 uses one or more wearable devices with one or more processors and including, but are not limited to, wearable digital glasses 108, clothing 110, jewelry 112 (e.g., smart rings, smart earrings, etc.) and/or watches 114, with the automated wheelchair assistance apparatus 12. However, the present invention is not limited to such embodiments and more, fewer and other types of wearable devices can also be used to practice the invention.

In one specific embodiment, the application 46, 46a interacts with wearable devices 108-114 providing automated wheelchair assistance services with the methods described herein. However, the present invention is not limited this embodiment and other embodiments can also be used to practice the invention.

### Artificial Intelligence (AI) and Big Data

“Artificial intelligence” (AI), also known as machine intelligence (MI), is intelligence demonstrated by machines, in contrast to the natural intelligence (NI) displayed by humans and other animals. AI research is defined as the study of “intelligent agents.” Intelligent agents are any software application or hardware device that perceives its environment and takes actions that maximize its chance of successfully achieving its goals. Colloquially, the term “artificial intelligence” is applied when a machine mimics “cognitive” functions that humans associate with human brains, such as learning, problem solving and comparing large number of data points.

In one embodiment, the present invention uses one or more AI methods including, but are not limited to, AI knowledge-based methods for automated wheelchair assistance services. The AI knowledge-based methods include determining a wheelchair 32 user's 33: movement patterns, wheeling patterns, wheeling paths and wheeling locations. However, the present invention is not limited to such an embodiment and more, fewer and/or other AI methods can be used to practice the invention.

In one embodiment, SaaS 80 cloud software application includes and AI application with the AI methods described herein. In another embodiment, the AI application is a standalone application. However, the present invention is not limited to such an embodiment, and the AI application can be provided in other than the SaaS 80.

“Big Data” refers to the use of predictive analytic methods that extract value from data, and to a particular size of data set. The quantities of data used are very large, at least 100,000 data points and more typically 500,000 to 1 Million+ data points. Analysis of Big Data sets are used to find new correlations and to spot trends. In one embodiment, SaaS includes and Big Data application with the Big Data described herein.

In one embodiment, the AI methods described herein collect data information to create and store (e.g., in cloud storage object 92, etc.) a Big Data that is used to analyze trends find new correlations and to spot trends. However, the present invention is not limited to such an embodiment and the AI methods described herein can be used without Big Data sets.

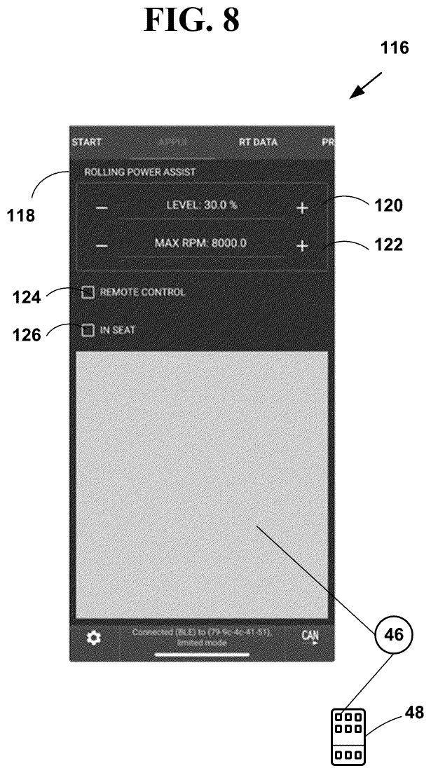

FIG. 8 is a block diagram 116 illustrating a display screen 118 of a wheelchair application 46 for a network device 48 used with an automated wheelchair assistance apparatus 12.

FIG. 8 illustrates the display screen 118 of the wheelchair application 46 for the network device 48 (e.g., smart phone, etc.) displaying a power level controller 120, a revolutions per minute (RPM) controller 122 to control motion of the wheels of the manual wheelchair 32, and a first selector 124 to select use the network device 48 a remote control device to move the wheelchair 32 from a first location to a second location occupied by a user 33 and/or to move the wheelchair away from the user to third location away from the user 33 when the user is no longer sitting in the wheelchair, and a second selector 126 to use the network device to adjust the power 120 and RPMs 122 when the user 33 is sitting in the wheelchair 32. However, the present invention is not limited to such an embodiment and more, fewer and/or other selectors can be used and displayed by the wheelchair application 46 on the network device 48.

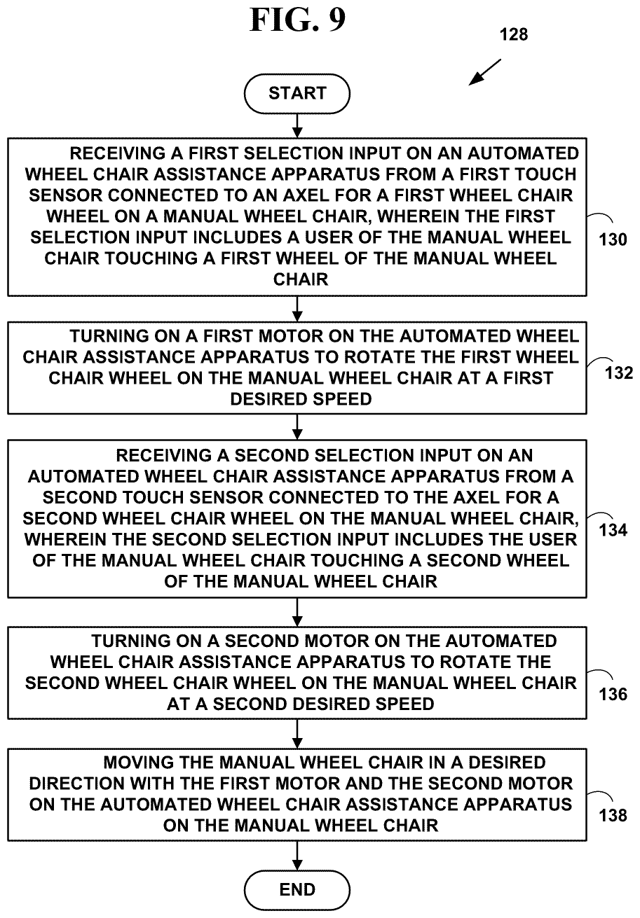

FIG. 9 is a flow diagram illustrating a method 128 for automated wheelchair assistance.

In FIG. 9, at Step 130, receiving a first selection input on an automated wheelchair assistance apparatus from a first touch sensor connected to an axle for a first wheelchair wheel on a manual wheelchair, wherein the first selection input includes a user of the manual wheelchair touching the first wheel of the manual wheelchair. At Step 132, turning on a first motor on the automated wheelchair assistance apparatus to rotate the first wheelchair wheel on the manual wheelchair at a first desired speed. At Step 134, receiving a second selection input on an automated wheelchair assistance apparatus from a second touch sensor connected to the axle for a second wheelchair wheel on the manual wheelchair, wherein the second selection input includes the user of the manual wheelchair touching a second wheel of the manual wheelchair. At Step 136, turning on a second motor on the automated wheelchair assistance apparatus to rotate the second wheelchair wheel on the manual wheelchair at a second desired speed. At Step 138, moving the manual wheelchair in a desired direction with the first motor and the second motor on the automated wheelchair assistance apparatus on the manual wheelchair. However, the present invention is not limited to such an embodiment and other embodiments where the automated wheelchair assistance apparatus is attached to other parts of the manual wheelchair other than the axle can be used to practice the invention.

Method 128 is illustrated with an exemplary embodiment. However, the present invention is not limited to such an embodiment and other embodiments can be used to practice the invention.

In such an exemplary embodiment in FIG. 9, at Step 130, receiving a first selection input on an automated wheelchair assistance apparatus 12 from a first touch sensor 18 connected to an axle 64 for a first wheelchair wheel 28, 30 on a manual wheelchair 32 wherein the first selection input includes a user 33 of the manual wheelchair 32 touching the first wheel 28, 30 of the manual wheelchair 32.

At Step 132, turning on a first motor 22 on the automated wheelchair assistance apparatus 12 to rotate the first wheelchair wheel 28, 30 on the manual wheelchair 32 at a first desired speed.

At Step 134, receiving a second selection input on an automated wheelchair assistance apparatus 12 from a second touch sensor 20 connected to the axle 64 for a second wheelchair wheel 34, 36 on the manual wheelchair 32, wherein the second selection input includes the user 33 of the manual wheelchair 32 touching the second wheel 34, 36 of the manual wheelchair 32.

At Step 136, turning on a second motor 24 on the automated wheelchair assistance apparatus 12 to rotate the second wheelchair wheel 34, 36 on the manual wheelchair at a second desired speed.

At Step 138, moving the manual wheelchair 32 in a desired direction with the first motor 22 and the second motor 24 on the automated wheelchair assistance apparatus 12 on the manual wheelchair 32.

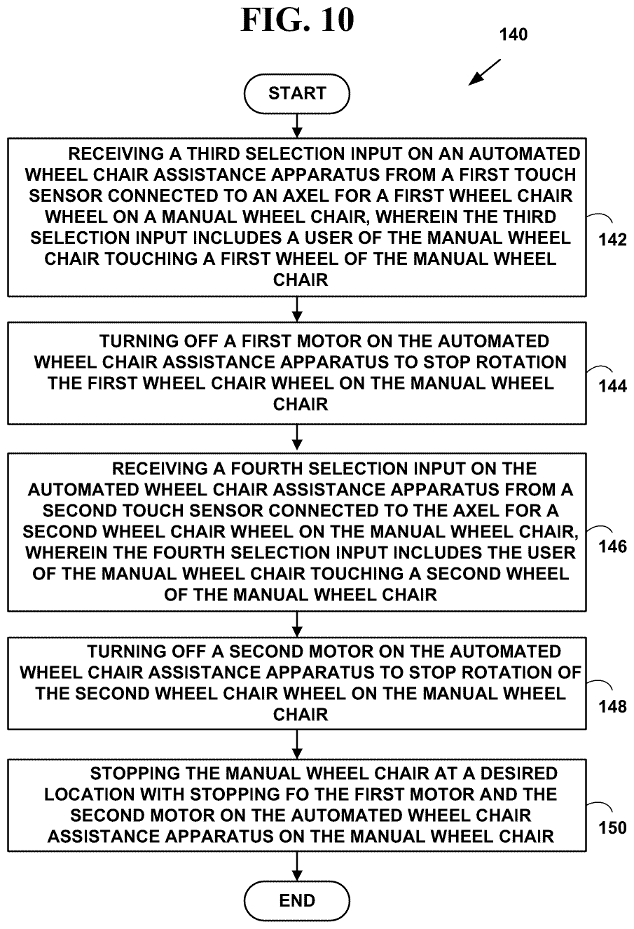

FIG. 10 is a flow diagram illustrating a method 140 for automated wheelchair assistance.

In FIG. 10 at Step 142, receiving a third selection input on the automated wheelchair assistance apparatus from the first touch sensor connected to the axle for the first wheelchair wheel on the manual wheelchair, wherein the third selection input includes the user of the manual wheelchair touching the first wheel of the manual wheelchair. At Step 144, turning off the first motor on the automated wheelchair assistance apparatus to stop rotate the first wheelchair wheel on the manual wheelchair. At Step 146, receiving a fourth selection input on the automated wheelchair assistance apparatus from the second touch sensor connected to the axle for the second wheelchair wheel on the manual wheelchair, wherein the fourth selection input includes the user of the manual wheelchair touching the second wheel of the manual wheelchair. At Step 148, turning the second motor off via the automated wheelchair assistance apparatus to stop rotation of the second wheelchair wheel on the manual wheelchair. At Step 150, stopping the manual wheelchair at a desired location with stopping of the first motor and the second motor on the automated wheelchair assistance apparatus on the manual wheelchair. However, the present invention is not limited to such an embodiment and other embodiments where the automated wheelchair assistance apparatus is attached to other parts of the manual wheelchair other than the axle can be used to practice the invention.

Method 140 is illustrated with an exemplary embodiment. However, the present invention is not limited to such an embodiment and other embodiments can be used to practice the invention.

In such an exemplary embodiment in FIG. 10, at Step 142, receiving a third selection input on the automated wheelchair assistance apparatus 12 from the first touch sensor 18 connected to the axle 64 for the first wheelchair wheel 28, 20 on the manual wheelchair 32, wherein the third selection input includes the user 33 of the manual wheelchair 32 touching the first wheel 28, 30 of the manual wheelchair 32.

At Step 144, turning off the first motor 22 on the automated wheelchair assistance apparatus 22 to stop rotation of the first wheelchair wheel 28, 30 on the manual wheelchair 32.

At Step 146, receiving a fourth selection input on the automated wheelchair assistance apparatus 12 from the second touch sensor 20 connected to the axle 64 for the second wheelchair wheel 34, 36 on the manual wheelchair 32, wherein the fourth selection input includes the user 33 of the manual wheelchair 32 touching the second wheel 34, 36 of the manual wheelchair 32.

At Step 148, turning the second motor 24 off via the automated wheelchair assistance apparatus 12 to stop rotation of the second wheelchair wheel 34, 36 on the manual wheelchair 32.

At Step 150, stopping the manual wheelchair 32 at a desired location with stopping of the first motor 22 and the second motor 24 on the automated wheelchair assistance apparatus 12 on the manual wheelchair 32.

For Methods 128 and 140, the first selection input and the second selection input, the third selection input and the fourth selection inputs occur simultaneously as a user 33 of the manual wheelchair 32 grabs both wheels 28, 30, 34, 36 of the manual wheelchair 32 at a same time and/or the first selection input and the second selection input, the third selection input and the fourth selection inputs occur at different times as a user 33 of the manual wheelchair 32 grabs both wheels 28, 30, 34, 36 of the manual wheelchair 32 at different times.

In one embodiment, the first touch sensor 22 and the second touch sensor 24 in contact with the axle 60 of the manual wheelchair 32 and also in contact with inner surfaces of the wheels 28, 30, 34, 36 of the manual wheelchair 32. When a user 33 of the manual wheelchair 32 including the automated wheelchair assistance apparatus 12 touches an outer surface of the wheels 28, 30, 34, 36 of the manual wheelchair 32, the touches result in a closing and/or opening of touch circuits first touch sensor 22 and the second touch sensor 24 because the axle 60 of the manual wheelchair is metal and the rims of the wheels 28, 34 are metal as all the metals are conductor.

In another embodiment, where the wheels 28, 30, 34, 36 of the manual wheelchair may not be metal, then the automated wheelchair assistance apparatus 12 is attached with first touch sensor 20 and the second touch sensor 24 on axle wheel hubs 64 (FIG. 3) to detecting touching of the wheels 28, 30, 34, 36 of the manual wheelchair 32 by a user 33. However, the present invention is not limited to such an embodiment and other embodiments can be used to practice the invention.

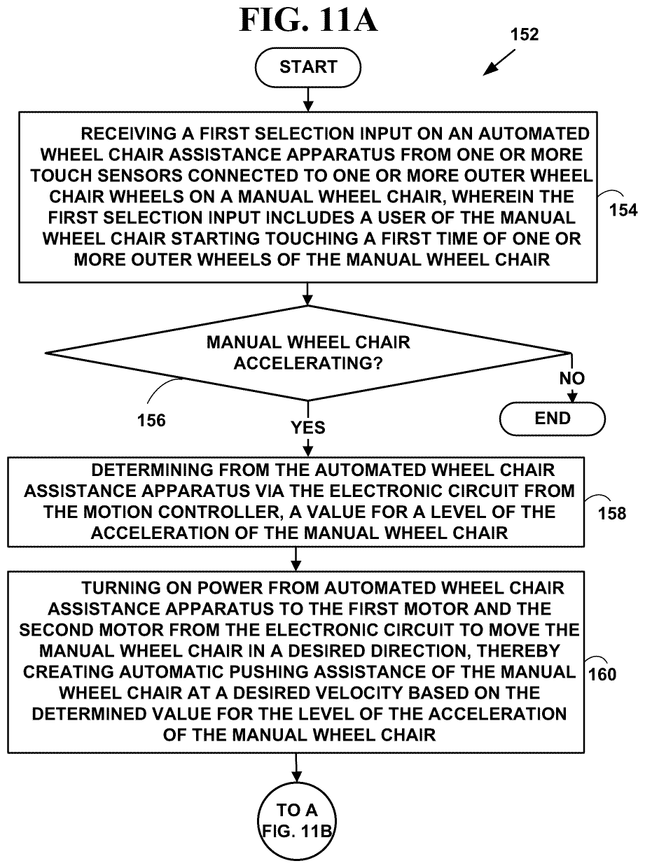

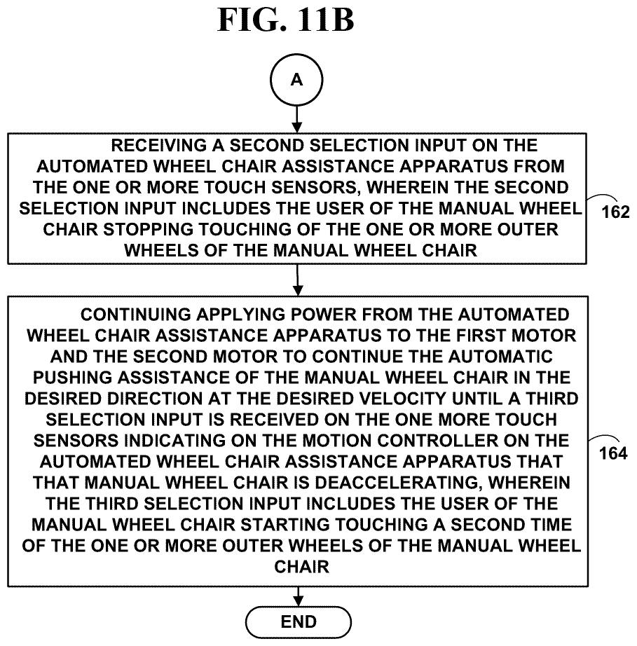

FIGS. 11A and 11B are a flow diagram illustrating a Method 152 for automated wheelchair assistance.

In FIG. 11A at Step 154, receiving a first selection input on an automated wheelchair assistance apparatus from one or more touch sensors connected one or more outer wheelchair wheels on a manual wheelchair, wherein the first selection input includes a user of the manual wheelchair starting touching a first time of the one or more outer wheels of the manual wheelchair; At Step 156, determining from the automated wheelchair assistance apparatus with a motion controller connected to an electronic circuit on the automated wheelchair assistance apparatus, whether the manual wheelchair is accelerating, and if so, at Step 158, determining from the automated wheelchair assistance apparatus via the electronic circuit from the motion controller, a value for a level of the acceleration of the manual wheelchair, and At Step 160, turning on power from automated wheelchair assistance apparatus to the first motor and the second motor from the electronic circuit to move the manual wheelchair in a desired direction, thereby creating automatic push assistance of the manual wheelchair at a desired velocity based on the determined value for the level of the acceleration of the manual wheelchair; In FIG. 11B at Step 162, receiving a second selection input on the automated wheelchair assistance apparatus from the one or more touch sensors, wherein the second selection input includes the user of the manual wheelchair stopping touching of the one or more outer wheels of the manual wheelchair; at Step 164, continuing applying power from the automated wheelchair assistance apparatus to the first motor and the second motor to continue the automatic push assistance of the manual wheelchair in the desired direction at the desired velocity until a third selection input is received on the one more touch sensors indicating on the motion controller on the automated wheelchair assistance apparatus that manual wheelchair is deaccelerating, wherein the third selection input includes the user of the manual wheelchair starting touching a second time of the one or more outer wheels of the manual wheelchair.

Method 152 is illustrated with an exemplary embodiment. However, the present invention is not limited to such an embodiment and other embodiments can be used to practice the invention.

In such an exemplary embodiment in FIG. 11A, at Step 152, receiving a first selection input on an automated wheelchair assistance apparatus 12 from one or more touch sensors 22, 24 connected to one or more outer wheelchair wheels 28, 34, on a manual wheelchair 32, wherein the first selection input includes a user 33 of the manual wheelchair 32 starting touching a first time of the one or more outer wheels 28, 34 of the manual wheelchair 32.

At Step 156, determining from the automated wheelchair assistance apparatus 12 with a motion controller 15 connected to an electronic circuit 16 on the automated wheelchair assistance apparatus 12, whether the manual wheelchair 32 is accelerating. The motion controller 15 is sensitive enough that it takes on only very small, minor motions (e.g. a small push, pull, grab, etc.) and/or touch contacts by the user 33 of the manual wheelchair 32 to determine if the manual wheelchair is accelerating or deaccelerating.

If the manual wheelchair is accelerating at Step 156 then, at Step 158, determining from the automated wheelchair assistance apparatus 12 via the electronic circuit 16 from the motion controller 15, a value for a level of the acceleration of the manual wheelchair 32.

In one embodiment, the value for the acceleration includes a meter-per-second squared (m/s²), acceleration value, which is a unit of acceleration in the International System of Units (SI). However, the present invention is not limited to this acceleration value and other acceleration values can be used to practice the invention.

At Step 160, turning on power (e.g., from power source 14) from automated wheelchair assistance apparatus 12 to the first motor 18 and the second motor 20 from the electronic circuit 16 to move the manual wheelchair 32 in a desired direction, thereby creating automatic push assistance of the manual wheelchair 32 at a desired velocity based on the determined value for the level of the acceleration of the manual wheelchair 32.

In one embodiment, a velocity includes, but is not limited to, a combination of a direction and a motion of an object, including the direction and motion of the manual wheelchair 32. In one embodiment, the velocity includes, but is not limited to, a revolutions-per-minute (RPM) value. In one embodiment, the velocity includes a desired speed. A speed includes, but is not limited to, a timed rate at which an object is moving along a path. A speed and velocity of an object is equal when the object moves without any change in direction and/or moves in a straight-line motion. However, the present invention is not limited to these velocity and/or speed measurements and other measurements can be used to practice the invention.

In FIG. 11B at Step 162, receiving a second selection input on the automated wheelchair assistance apparatus 12 from the one or more touch sensors 22, 24, wherein the second selection input includes the user 33 of the manual wheelchair 32 stopping touching of the one or more outer wheels 28, 34 of the manual wheelchair 32.

At Step 164, continuing applying power 14 from the automated wheelchair assistance apparatus 12 to the first motor 18 and the second motor 20 to continue the automatic push assistance of the manual wheelchair 32 in the desired direction at the desired velocity until a third selection input is received on the one more touch sensors 22, 24 indicating on the motion controller 15 on the automated wheelchair assistance apparatus 12 that manual wheelchair 32 is deaccelerating, wherein the third selection input includes the user 33 of the manual wheelchair 32 starting touching a second time of the one or more outer wheels 28, 34 of the manual wheelchair 32.

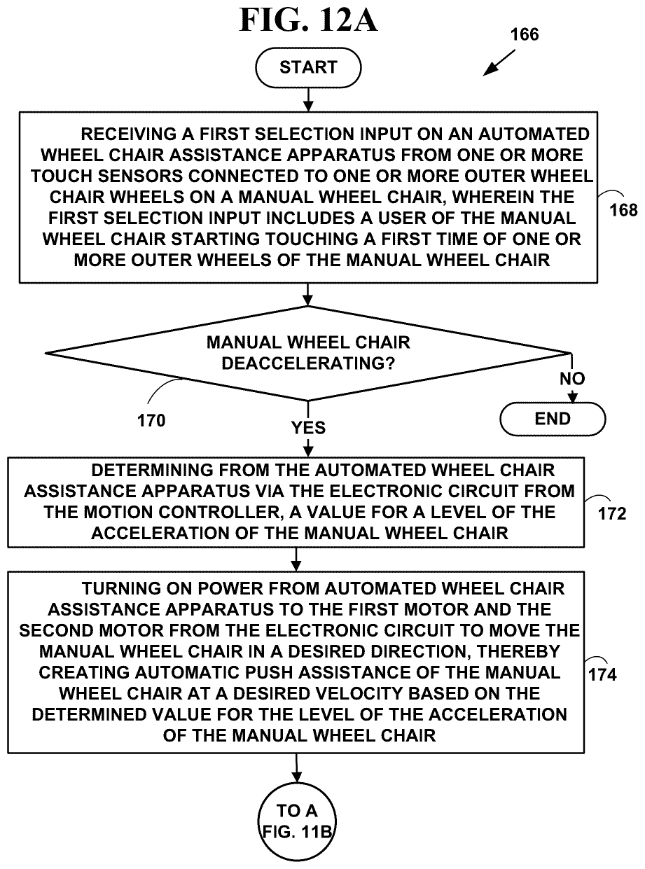

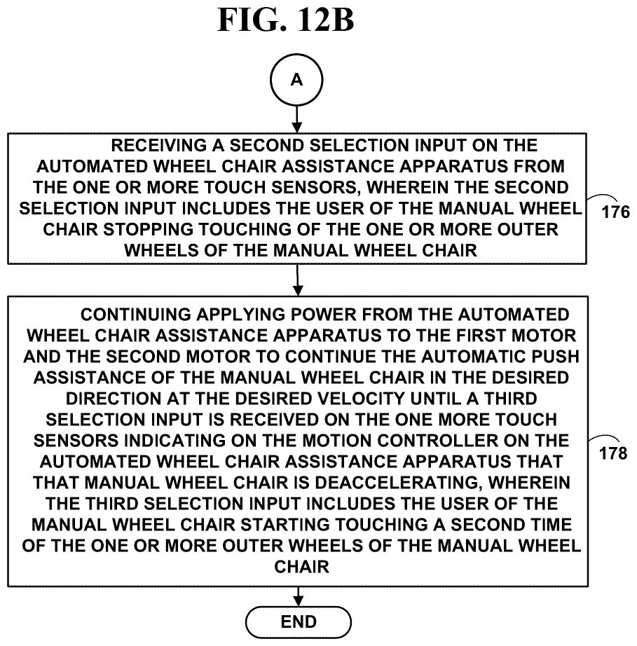

FIGS. 12A and 12B are a flow diagram illustrating a Method 166 for automated wheelchair assistance.

In FIG. 12A, at Step 168, receiving a first selection input on an automated wheelchair assistance apparatus from one or more touch sensors connected one or more outer wheelchair wheels on a manual wheelchair, wherein the first selection input includes a user of the manual wheelchair starting touching a first time of one or more outer wheels of the manual wheelchair; At Step 170, determining from the automated wheelchair assistance apparatus with a motion controller connected to an electronic circuit on the automated wheelchair assistance apparatus, whether the manual wheelchair is deaccelerating, and if so, at Step 172, determining from the automated wheelchair assistance apparatus via the electronic circuit from the motion controller, a value for a level of the deacceleration of the manual wheelchair, and at Step 174, adjusting power from automated wheelchair assistance apparatus to the first motor and the second motor from the electronic circuit to move the manual wheelchair in a desired direction, thereby creating automatic braking assistance of the manual wheelchair at a desired velocity based on the determined value for the level of the deacceleration of the manual wheelchair; In FIG. 12B, at Step 176, receiving a second selection input on the automated wheelchair assistance apparatus from the one or more touch sensors, wherein the second selection input includes the user of the manual wheelchair stopping touching of the one or more outer wheels of the manual wheelchair; At Step 178, continuing adjusting power from the automated wheelchair assistance apparatus to the first motor and the second motor to continue the automatic braking assistance of the manual wheelchair in the desired direction at the desired velocity until a third selection input is received on the one more touch sensors indicating on the motion controller on the automated wheelchair assistance apparatus that manual wheelchair is deaccelerating, wherein the third selection input includes the user of the manual wheelchair starting touching a second time of the one or more outer wheels of the manual wheelchair.

Method 168 is illustrated with an exemplary embodiment. However, the present invention is not limited to such an embodiment and other embodiments can be used to practice the invention.

In such an exemplary embodiment in FIG. 12A, at Step 168, receiving a first selection input on an automated wheelchair assistance apparatus 12 from one or more touch sensors 22, 24 connected to one or more outer wheelchair wheels 28, 34 on a manual wheelchair 32, wherein the first selection input includes a user 33 of the manual wheelchair 32 starting touching a first time of one or more outer wheels 28, 24 of the manual wheelchair 32.

At Step 170, determining from the automated wheelchair assistance apparatus 12 with a motion controller 15 connected to an electronic circuit 16 on the automated wheelchair assistance apparatus 12, whether the manual wheelchair 32 is deaccelerating.

If the manual wheelchair 32 is deaccelerating at Step 170, then at Step 172, determining from the automated wheelchair assistance apparatus 12 via the electronic circuit 16 from the motion controller 15, a value for a level of the deacceleration of the manual wheelchair 32.

At Step 174, adjusting power 14 from automated wheelchair assistance apparatus 12 to the first motor 18 and the second motor 20 from the electronic circuit 16 to move the manual wheelchair in a desired direction, thereby creating automatic braking assistance of the manual wheelchair 32 at a desired velocity based on the determined value for the level of the deacceleration of the manual wheelchair 32.

In FIG. 12B, at Step 176, receiving a second selection input on the automated wheelchair assistance apparatus 12 from the one or more touch sensors 22, 24, wherein the second selection input includes the user 33 of the manual wheelchair 32 stopping touching of the one or more outer wheels 28, 34 of the manual wheelchair 32.

At Step 178, continuing adjusting power 14 from the automated wheelchair assistance apparatus 12 to the first motor 18 and/or the second motor 20 to continue the automatic braking assistance of the manual wheelchair 32 in the desired direction at the desired velocity until a third selection input is received on the one more touch sensors 22, 24 indicating on the motion controller 15 on the automated wheelchair assistance apparatus 12 that manual wheelchair 32 is deaccelerating, wherein the third selection input includes the user 33 of the manual wheelchair 32 starting touching a second time of the one or more outer wheels 28, 34 of the manual wheelchair 32.

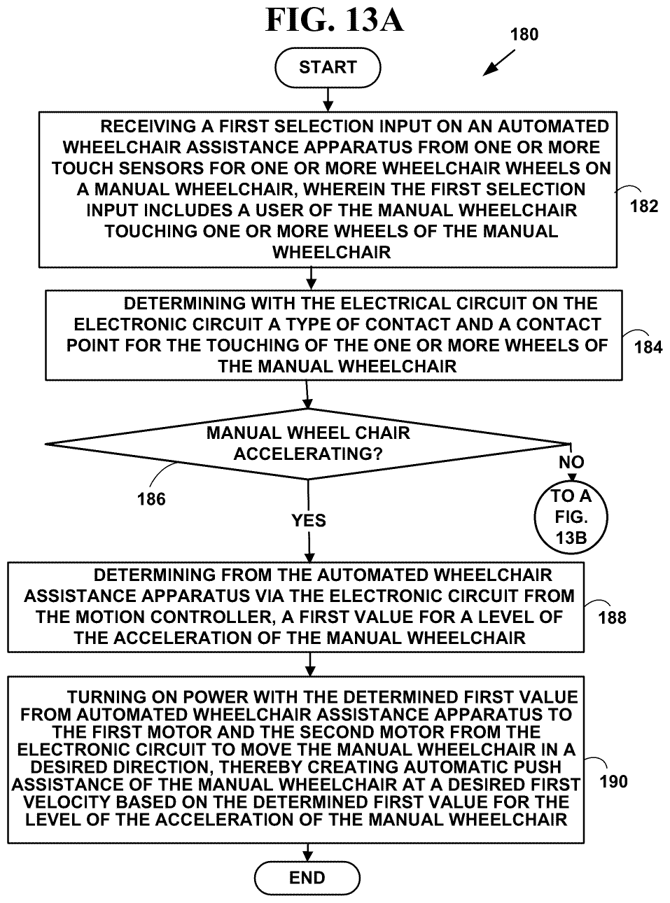

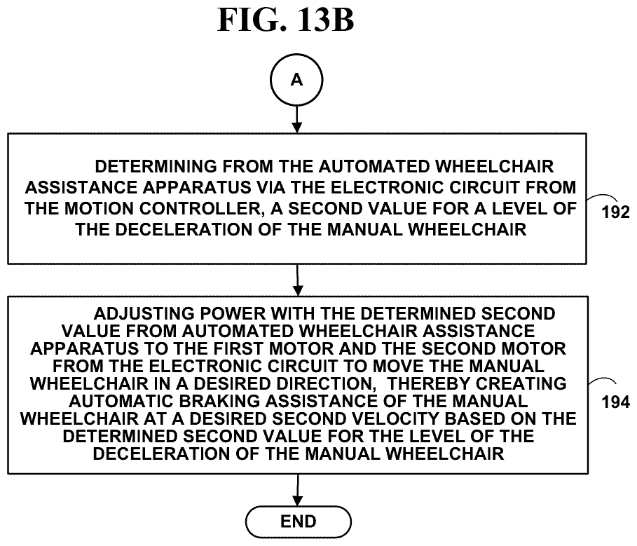

FIGS. 13A and 13B are a flow diagram illustrating a Method 180 for automated wheelchair assistance.

In FIG. 13A at Step 182, receiving a first selection input on an automated wheelchair assistance apparatus from one or more touch sensors for one or more wheelchair wheels on a manual wheelchair, wherein the first selection input includes a user of the manual wheelchair touching one or more wheels of the manual wheelchair; at Step 184, determining with the electrical circuit on the electronic circuit a type of contact and contact point for the touching of the one or more wheels of the manual wheelchair; and at Step 186, determining from the automated wheelchair assistance apparatus with a motion controller connected to the electronic circuit on the automated wheelchair assistance apparatus, with the determined type of contract and contact point, whether the manual wheelchair is accelerating or deaccelerating, At Step 188, if the manual wheelchair is accelerating, determining from the automated wheelchair assistance apparatus via the electronic circuit from the motion controller, a first value for a level of the acceleration of the manual wheelchair, and at Step 190 turning on power with the determined first value from automated wheelchair assistance apparatus to the first motor and the second motor from the electronic circuit to move the manual wheelchair in a desired direction, thereby creating automatic push assistance of the manual wheelchair at a desired velocity based on the determined first value for the level of the acceleration of the manual wheelchair, and if the manual wheel chair is deaccelerating in FIG. 13A at Step 186, in FIG. 13B at Step 192, determining from the automated wheelchair assistance apparatus via the electronic circuit from the motion controller, a second value for a level of the deacceleration of the manual wheelchair, and at Step 194 adjusting power with the determined second value from automated wheelchair assistance apparatus to the first motor and the second motor from the electronic circuit to move the manual wheelchair in a desired direction, thereby creating automatic braking assistance of the manual wheelchair at a desired velocity based on the determined second value for the level of the deacceleration of the manual wheelchair.

Method 180 is illustrated with an exemplary embodiment. However, the present invention is not limited to such an embodiment and other embodiments can be used to practice the invention.

In such an exemplary embodiment in FIG. 13A at Step 182, receiving a first selection input on an automated wheelchair assistance apparatus 12 from one or more touch sensors 22, 24 for one or more wheelchair wheels 28, 30, 34, 36 on a manual wheelchair 32, wherein the first selection input includes a user 33 of the manual wheelchair 32 touching one or more wheels 28, 30, 34, 36 of the manual wheelchair 32.

At Step 184, determining with the electrical circuit 16 on the automated wheelchair assistance apparatus 12 a type of contact and a contact point for the touching of the one or more wheels 28, 30, 34, 36 of the manual wheelchair 32.

In one embodiment, the type of contact includes, but is not limited to, a pushing contact, a pulling contact and/or a stopping contact. However, the present invention is not limited to such embodiments and other types of contact types can be used to practice the invention.

In one embodiment, the contact point, includes but is not limited to a surface of the outer wheel 28, 34 and/or inner wheel 30, 36 and/or a rim for the outer wheel 28, 34 and/or inner wheel 30, 36. However, the present invention is not limited to such embodiments and other types of contact points can be used to practice the invention.

At Step 186, a test is conducted, determining from the automated wheelchair assistance apparatus 12 with a motion controller 15 connected to the electronic circuit 16 on the automated wheelchair assistance apparatus 12, whether the manual wheelchair 32 is accelerating or deaccelerating.

At Step 188, if the manual wheelchair 32 is accelerating, determining from the automated wheelchair assistance apparatus 12 via the electronic circuit 16 from the motion controller 16, a first value for a level of the acceleration of the manual wheelchair 32.

At Step 190, turning on power 14 from automated wheelchair assistance apparatus 12 to the first motor 18 and the second motor 20 from the electronic circuit 16 to move the manual wheelchair 32 in a desired direction, thereby creating automatic push assistance of the manual wheelchair 32 at a desired velocity based on the determined first value for the level of the acceleration of the manual wheelchair 32.

If the manual wheel chair 32 is deaccelerating in FIG. 13A at Step 186, then in FIG. 13B at Step 192, determining from the automated wheelchair assistance apparatus 12 via the electronic circuit 16 from the motion controller 15, a second value for a level of the deacceleration of the manual wheelchair 32.

At Step 194, adjusting power with the determined second value from automated wheelchair assistance apparatus 12 to the first motor 18 and the second motor 20 from the electronic circuit 16 to move the manual wheelchair in the desired direction, thereby creating automatic braking assistance of the manual wheelchair 32 at a second desired velocity based on the determined second value for the level of the deacceleration of the manual wheelchair 32.

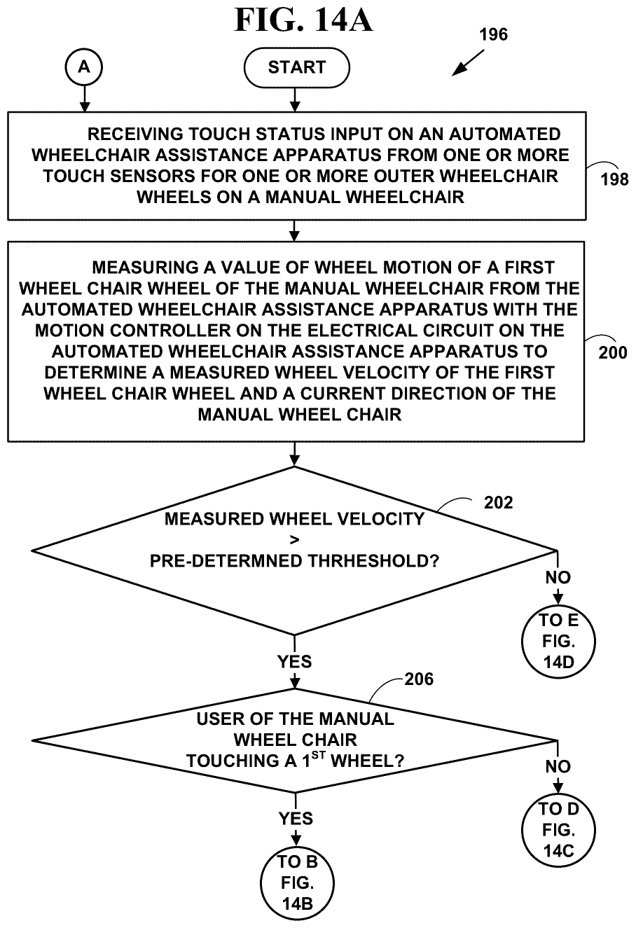

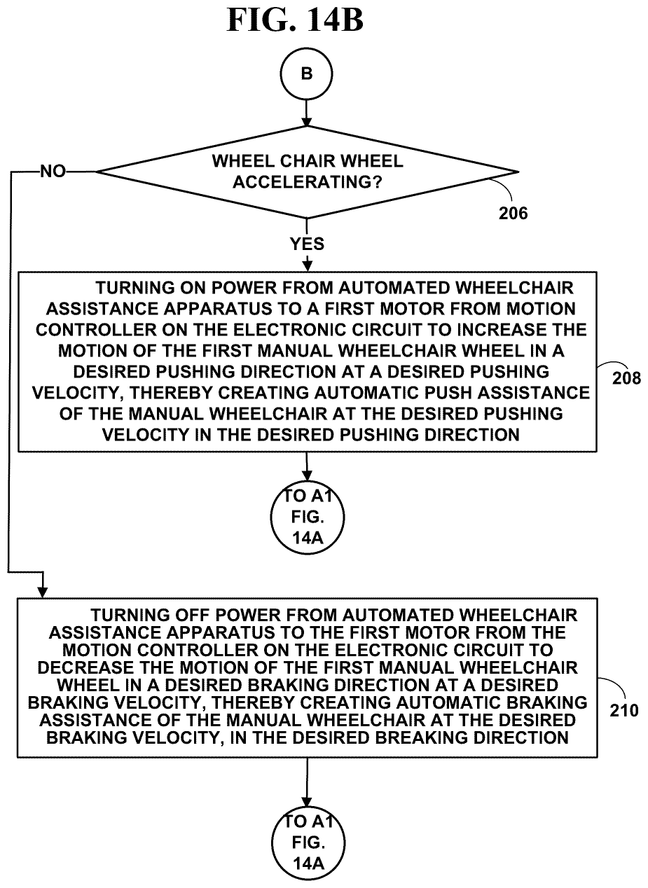

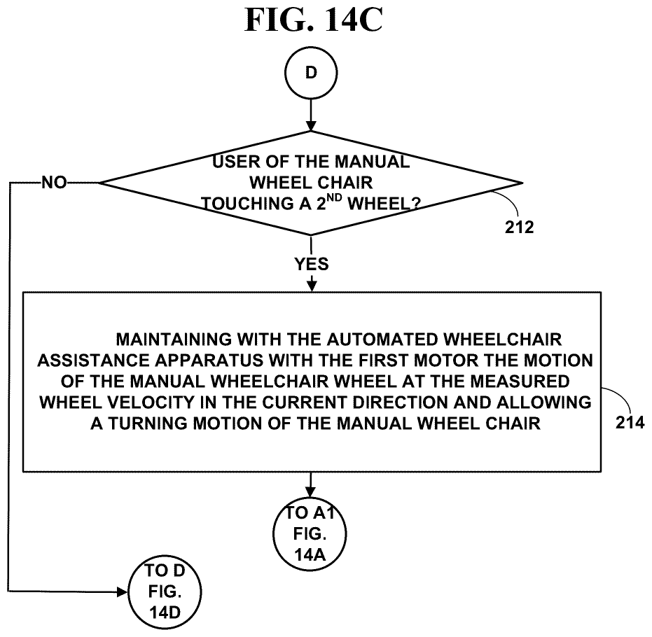

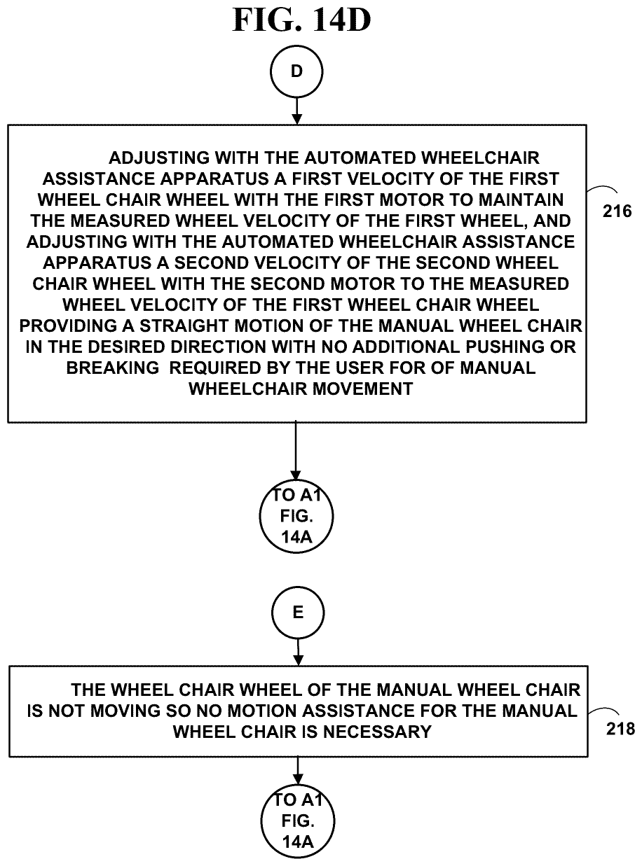

FIGS. 14A through 14D are a flow diagram illustrating a Method 196 for automated wheelchair assistance.

In FIG. 14A at Step 198, receiving touch status input on an automated wheelchair assistance apparatus from one or more touch sensors for one or more outer wheelchair wheels on a manual wheelchair. At Step 200, measuring a value of wheel motion of a first wheel chair wheel of the manual wheelchair from the automated wheelchair assistance apparatus with the motion controller on the electrical circuit on the automated wheelchair assistance apparatus to determine a measured wheel velocity of the first wheel chair wheel and a current direction of the manual wheel chair. At Step 202, conducting a first test on the automated wheelchair assistance apparatus on the motion controller on the electrical circuit to determine whether the measured wheel velocity of the first wheel chair wheel is above a pre-determined minimum velocity threshold to define the first wheelchair wheel as moving at the measured wheel velocity in the current direction, and if so, At Step 204 conducting a second test on the automated wheelchair assistance apparatus on the with a first touch sensor on the electrical circuit to determine if the user of the manual wheel chair is touching the first wheel chair wheel, and if so, At Step 206 in FIG. 14B, conducting a third test on the automated wheelchair assistance apparatus on the motion controller on the electronic circuit to determine if the measured wheel motion value indicates the first wheel chair wheel is accelerating, and if so, at Step 208, turning on power from automated wheelchair assistance apparatus to a first motor from motion controller on the electronic circuit to increase the motion of the first manual wheelchair wheel in a desired pushing direction at a desired pushing velocity, thereby creating automatic push assistance of the manual wheelchair at the desired pushing velocity in the desired pushing direction, and if not, At Step 210, turning off power from automated wheelchair assistance apparatus to the first motor from the motion controller on the electronic circuit to decrease the motion of the first manual wheelchair wheel in a desired braking direction at a desired braking velocity, thereby creating automatic braking assistance of the manual wheelchair at the desired braking velocity, in the desired breaking direction, and if the first wheel chair wheel is not accelerating, in FIG. 14C at Step 212, conducting a fourth test on the automated wheelchair assistance apparatus on the electronic circuit with the one or more touch sensors to determine if the user of the manual wheelchair is touching any of the wheel chair wheels of the manual wheel chair, and if so, At Step 214, maintaining with the automated wheelchair assistance apparatus with the first motor the motion of the manual wheelchair wheel at the measured wheel velocity in the current direction and allowing a turning motion of the manual wheel chair with no automatic push assistance or automatic breaking assistance required for the manual wheel chair, and if not, in FIG. 14D at Step 216, adjusting with the automated wheelchair assistance apparatus a first velocity of the first wheel chair wheel with the first motor to maintain the measured wheel velocity of the first wheel, and adjusting with the automated wheelchair assistance apparatus a second velocity of the second wheel chair wheel with the second motor to the measured wheel velocity of the first wheel chair wheel providing a straight motion of the manual wheel chair in the desired direction with no additional pushing or breaking required by the user for the manual wheelchair movement, and back in FIG. 14A at Step 202, if the measured wheel velocity of the first wheel chair wheel is not above the pre-determined minimum velocity threshold, then the first wheel chair wheel of the manual wheel chair is not moving so no motion assistance for the manual wheel chair is necessary.

Method 196 is illustrated with an exemplary embodiment. However, the present invention is not limited to such an embodiment and other embodiments can be used to practice the invention.

In such an exemplary embodiment in FIG. 14A, at Step 198, receiving touch status input on an automated wheelchair assistance apparatus 12 from one or more touch sensors 22, 24 for one or more outer wheelchair wheels on a manual wheelchair 32.

At Step 200, measuring a value of wheel motion of a first wheel chair wheel 30 of the manual wheelchair 32 from the automated wheelchair assistance apparatus 12 with the motion controller 15 on the electrical circuit 16 on the automated wheelchair assistance apparatus 12 to determine a measured wheel velocity of the first wheel chair wheel 32 and a current direction 35 of the manual wheel chair 32.

At Step 202, conducting a first test on the automated wheelchair assistance apparatus 12 on the motion controller 15 on the electrical circuit 16 to determine whether the measured wheel velocity of the first wheel chair wheel 30 is above a pre-determined minimum velocity threshold to define the first wheelchair wheel 30 as moving at the measured wheel velocity in the current direction 35.

And if so, at Step 204, conducting a second test on the automated wheelchair assistance apparatus 12 on the with a first touch sensor 22 on the electrical circuit 16 to determine if the user 33 of the manual wheel chair 32 is touching the first wheel chair wheel 30.

And if so, at Step 206, in FIG. 14B, conducting a third test on the automated wheelchair assistance apparatus 12 on the motion controller 15 on the electronic circuit 16 to determine if the measured wheel motion value indicates the first wheel chair wheel 30 is accelerating.

And if so, at Step 208, turning on power from automated wheelchair assistance apparatus 12 to a first motor 18 from motion controller 15 on the electronic circuit 16 to increase the motion of the first manual wheelchair wheel 30 in a desired pushing direction at a desired pushing velocity, thereby creating automatic push assistance of the manual wheelchair 32 at the desired pushing velocity in the desired pushing direction.

And if not, at Step 210, turning off power from automated wheelchair assistance apparatus 12 to the first motor 18 from the motion controller 15 on the electronic circuit 16 to decrease the motion of the first manual wheelchair wheel 30 in a desired braking direction at a desired braking velocity, thereby creating automatic braking assistance of the manual wheelchair at the desired braking velocity, in the desired breaking direction, and if the first wheel chair wheel 30 is not accelerating.

In FIG. 14C at Step 212, conducting a fourth test on the automated wheelchair assistance apparatus 12 on the electronic circuit 16 with the one or more touch sensors 22, 24 to determine if the user 33 of the manual wheelchair 32 is touching any of the wheel chair wheels 30, 36 of the manual wheel chair 32.

And if so, at Step 214, maintaining with the automated wheelchair assistance apparatus 12 with the first motor 18 the motion of the manual wheelchair wheel 32 at the measured wheel velocity in the current direction 35 and allowing a turning motion of the manual wheel chair 32 with no automatic push assistance or automatic breaking assistance required for the manual wheel chair 32.

And if not, in FIG. 14D at Step 216 adjusting with the automated wheelchair assistance apparatus 12, a first velocity of the first wheel chair wheel 30 with the first motor 18 to maintain the measured wheel velocity of the first wheel 30, and adjusting with the automated wheelchair assistance apparatus 12, a second velocity of the second wheel chair wheel 36 with the second motor 20 to the measured wheel velocity of the first wheel chair wheel 30 providing a straight motion of the manual wheel chair 32 in the desired direction 35 with no additional pushing or breaking required by the user 33 for the manual wheelchair 32 movement.

And back in FIG. 14A at Step 202, if the measured wheel velocity of the first wheel chair wheel 30 is not above the pre-determined minimum velocity threshold, then in FIG. 14D at Step 218, the first wheel chair wheel 30 of the manual wheel chair 32 is not moving so no motion assistance for the manual wheel chair 32 is necessary.

The automated wheelchair assistance apparatus 12 does not require a joystick, touchpad or other controller to be installed on the arm rests of the manual wheelchair 32.

The automated wheelchair assistance apparatus 12 is activated by a user 33 simply touching the outer wheels 28, 36 of the manual wheelchair 32.

The automated wheelchair assistance apparatus 12 is deactivated by a user 33 simply touching the outer wheels 28, 36 of the manual wheelchair 32.

The automated wheelchair assistance apparatus 12 allows the manual wheelchair 32 to continue at a determined velocity in a same direction providing automatic push assistance when the wheels 28, 30, 34, 36 are not being touched at all, after an initial touch.

The automated wheelchair assistance apparatus 12 allows the manual wheelchair 32 to continue deacceleration in a same direction providing automatic braking assistance when the wheels 28, 30, 34, 36 are not being touched at all, after an initial touch.

The automated wheelchair assistance apparatus 12 reduces the number of pushes by a user 33 on the manual wheelchair wheels 28, 30, 34, 36 by continuing to move the manual wheelchair 32 at a desired velocity providing automatic push assistance after an initial touch of the manual wheelchair wheels 28, 30, 34, 36, thus decreasing a number of push repetitions and associated shoulder and hand grip injuries and fatigue of a wheelchair user 33 using a manual wheelchair 32 during a pushing process.

The automated wheelchair assistance apparatus 12 reduces the number of pushes by a user 33 on the manual wheelchair wheels 28, 30, 34, 36 by continuing to slow (i.e., apply breaking) the manual wheelchair 32 at a desired velocity providing automatic breaking assistance after an initial touch of the manual wheelchair wheels 28, 30, 34, 36, thus decreasing shoulder and hand grip injuries and fatigue of a wheelchair user 33 using a manual wheelchair 32 during a braking process.

A decreased number of pushes on the wheels 28, 30, 34, 36 of the manual wheelchair 32 also decreases wear pressures on hands, arms and shoulders of the user 33 and decreases risk of injury over time and also compensates for any upper body weakness of the user 33.

The automated wheelchair assistance apparatus 12 use a remote-controlled mobile device such as mobile phone, electronic tablet, computer, wearable device, etc. in order to move the manual wheelchair 32 to a user 33 from a remote location to use and move the manual wheelchair 32 automatically away from the user 33 after use and drive the wheelchair without physical input to wheels.

The automated wheelchair assistance apparatus 12 uses software applications 46 and/or cloud SaaS 80 applications, including Artificial Intelligence (AI) components 13 and/or sensors 15 to collect data to assist in regulating speed, assistance and control of navigation by a user 33 and to determine a precise physical location with GPS of the manual wheelchair 32.

The automated wheelchair assistance apparatus 12 is easily attachable to, and removable from, any manual wheelchair 32. The automated wheelchair assistance apparatus 12 weighs about ten pounds (about 4.5 kg).

It should be understood that the architecture, programs, processes, methods and systems described herein are not related or limited to any particular type of computer or network system (hardware or software), unless indicated otherwise. Various types of computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. § 112, paragraph 6, and any claim without the word “means” is not so intended. Therefore, all embodiments that come within the scope and spirit of the following claims and equivalents thereto are claimed as the invention.

I claim:

1. An automated wheelchair assistance apparatus, comprising in combination:
a power source;
an electronic circuit with one or more processors and a non-transitory computer readable medium connected to the power source for controlling a first touch sensor and a second touch sensor, a first motor, a second motor, a motion controller and a wireless interface;
the first touch sensor for sensing a first human touch of a first outer rim of a first wheelchair wheel of a wheelchair,
the first touch sensor for activating a first motor to automatically start movement of the first wheelchair wheel with a first human touch and deactivating the first motor to automatically stop movement of the first wheelchair wheel upon sensing of a third human touch;
the second touch sensor for sensing the first human touch of a second outer rim of a second wheelchair wheel of the wheelchair,
the second touch sensor for activating a second motor to automatically start movement of the second wheelchair wheel with a second human touch and deactivating the second motor to automatically stop movement of the second wheelchair wheel upon sensing of a fourth human touch;
a first roller in contact with the first wheelchair wheel to rotate the first wheelchair wheel;
a second roller in contact with the second wheelchair wheel to rotate the second wheelchair wheel;
the first motor connected to the electronic circuit and a first shaft of the first roller to rotate the first wheelchair wheel;
the second motor connected to the electronic circuit a second shaft of second roller to rotate the second wheelchair wheel;
the first motor and the second motor activated together by the electronic circuit for moving the wheelchair in a forward direction or backward direction, or the first motor and the second motor activated independently by the electronic circuit for moving the wheelchair in a plurality of different angular directions;
the motion controller including an accelerometer for sensing acceleration and deacceleration of the manual wheelchair providing automatic push assistance and automatic braking assistance and an inertial measurement unit (IMU) component for detecting movement in three dimensions (X, Y, Z); and
the wireless interface connected to the electric circuit for communicating with a wheelchair application on a network device with one or more processors via a communications network,
the wheelchair application allowing the wheelchair without a human occupant to be moved automatically with a selection input on the wheelchair application from a first location to a second location to be accessed by the human occupant, and automatically moved away to a third location from the human occupant after use,
drive the wheelchair without physical input to wheels, the wheelchair application on the network device further controlling a speed and a power generation of the first motor and the second motor.

2. The automated wheelchair assistance apparatus of claim 1, wherein the power source includes one or more batteries or one or more charged capacitors providing Direct Current (DC) power.

3. The automated wheelchair assistance apparatus of claim 1, wherein the electronic circuit one or more integrated circuit (IC) chips placed on one or more IC boards.

4. The automated wheelchair assistance apparatus of claim 1, wherein the first touch sensor and the second touch sensor include a sensing technology comprising one or more of a capacitive sensor, resistive sensor, acoustic wave sensor, pressure sensor, optical sensor or tactile touch sensor, a capacitive touch switch, a resistive touch switch or a piezo touch switch, or a combination thereof.

5. The automated wheelchair assistance apparatus of claim 1, wherein the first touch sensor and the second touch sensor include a wireless touch sensor or a touch sensor connected with a wire to one or more of the first wheel chair wheels and one or more of the second wheel chair wheels.

6. The automated wheelchair assistance apparatus of claim 1, wherein the first motor and the second motor include one or more of a brushed, steeper or brushless, direct current (DC) motor, or a combination thereof.

7. The automated wheelchair assistance apparatus of claim 1, wherein the first motor and the second motor include a skateboard hub motorized wheel including: a brushless direct current (DC) motor and shaft inside a roller in a single unit.

8. The automated wheelchair assistance apparatus of claim 1, wherein the wireless interface includes: an IEEE 802.11a, 802.11b, 802.11g, 802.11n, 802.15.4 (ZigBee), “Wireless Fidelity” (Wi-Fi), “Worldwide Interoperability for Microwave Access” (WiMAX), ETSI High Performance Radio Metropolitan Area Network (HIPERMAN), “RF Home”, BLUETOOTH (IEEE 802.15.1), Infra Data Association (IrDA), Radio Frequency Identifier (RFID), Near Field Communications (NFC), Machine-to-Machine (M2M), smart speaker, or Internet of Things (IoT), wireless interface.

9. The automated wheelchair assistance apparatus of claim 1, wherein the network device includes: desktop computers, laptop computers, tablet computers, mobile phones, non-mobile phones, smart phones, personal digital/data assistants (PDA), portable game consoles, non-portable game consoles, wearable network devices, Internet of Things (IoT) devices, cable television (CATV) set-top boxes, satellite television boxes, or digital televisions, including high-definition (HDTV) and three-dimensional (3D) televisions.

10. The automated wheelchair assistance apparatus of claim 1, wherein the communications network includes a cloud communications network and a non-cloud communications network, or a combination thereof.

11. The automated wheelchair assistance apparatus of claim 1, wherein the cloud communications network includes a cloud computing Infrastructure as a Service (IaaS), a cloud Platform as a Service (PaaS) and one or more cloud Software as a Service (Saas) services including a specific cloud software service wheelchair application for allowing the wheelchair without the human occupant to be moved automatically with the selection input on the SaaS from the first location to the second location to be accessed by the human occupant and controlling a speed and power generation of the first motor and the second motor.

12. The automated wheelchair assistance apparatus of claim 1, wherein the first touch sensor and the second touch sensor are included within an electrical insulating component within an axle for the first wheelchair wheel and the second wheelchair wheel.

13. The automated wheelchair assistance apparatus of claim 1, wherein the first touch sensor detects touch contact of a first metal outer rim of the first wheelchair wheel and the second touch sensor detects touch contact of a second metal outer rim of the second wheelchair wheel.

14. The automated wheelchair assistance apparatus of claim 1, wherein the first touch sensor detects touch contact of a second inner rim of the first wheelchair wheel and the second touch sensor detects touch contact of a second inner rim of the second wheelchair wheel.

15. The automated wheelchair assistance apparatus of claim 1, wherein the first touch sensor includes a first wireless sensor for detecting touch contact of one or more of the first wheelchair wheels and the second touch sensor includes a second wireless sensor for detecting touch contact of one or more of the second wheelchair wheels.

16. The automated wheelchair assistance apparatus of claim 1, wherein the first touch sensor includes a first sensor connected with a wire to one or more of the first wheelchair wheels detecting any touch contact of the one or more first wheel chair wheels, and the second touch sensor includes a second wired sensor connected to one or more of the second wheelchair wheels detecting any touch contact of the one or more second wheel chair wheels.

17. The automated wheelchair assistance apparatus of claim 1, wherein the first touch sensor is activated and a first touch sensor circuit is closed when the human occupant starts touching the first metal outer rim of the first wheelchair wheel, activating the first motor and the second touch sensor is activated and a second touch sensor circuit is closed when the human occupant starts touching the second metal outer rim of the second wheelchair wheel, activating the second motor.

18. The automated wheelchair assistance apparatus of claim 1, wherein the first touch sensor is deactivated and a first touch sensor circuit is opened when the human occupant stops touching the first metal outer rim of the first wheelchair wheel deactivating the first motor and the second touch sensor is deactivated and a second touch sensor circuit is opened when the human occupant stops touching the second metal outer rim of the second wheelchair wheel deactivating the second motor.

19. The automated wheelchair assistance apparatus of claim 1, further including one or more of: (1) a Global Positioning System (GPS) component; (2) a lighting component; (3) a smart speaker component; (4) an orientation sensor; or (5) a light sensor.

20. A method for automated wheelchair assistance, comprising:
receiving touch status input on an automated wheelchair assistance apparatus from one or more touch sensors for one or more outer wheelchair wheels on a manual wheelchair,
measuring a value of wheel motion of a first wheel chair wheel of the manual wheelchair from the automated wheelchair assistance apparatus with the motion controller on the electrical circuit on the automated wheelchair assistance apparatus to determine a measured wheel velocity of the first wheel chair wheel and a current direction of the manual wheel chair; and
conducting a first test on the automated wheelchair assistance apparatus on the motion controller on the electrical circuit to determine whether the measured wheel velocity of the first wheel chair wheel is above a pre-determined minimum velocity threshold to define the first wheel chair wheel as moving at the measured wheel velocity in the current direction,
and if so,
conducting a second test on the automated wheelchair assistance apparatus on the motion controller with a first touch sensor on the electrical circuit to determine if a user of the manual wheelchair is touching the first wheel chair wheel,
and if so,
conducting a third test on the automated wheelchair assistance apparatus on the motion controller on the electronic circuit to determine if the measured wheel motion value indicates the first wheel chair wheel is accelerating,
and if so,
turning on power from automated wheelchair assistance apparatus to a first motor from motion controller on the electronic circuit to increase the motion of the first manual wheelchair wheel in a desired pushing direction at a desired pushing velocity, thereby creating automatic push assistance of the manual wheelchair at the desired pushing velocity in the desired pushing direct,
and if not,
turning off power from automated wheelchair assistance apparatus to the first motor from the motion controller on the electronic circuit to decrease the motion of the first manual wheelchair wheel in a desired braking direction at a desired braking velocity, thereby creating automatic braking assistance of the manual wheelchair at the desired braking velocity, in the desired breaking direction,
and if not,
conducting a fourth test on the automated wheelchair assistance apparatus on the electronic circuit with the one or more touch sensors to determine if the user of the manual wheelchair is touching the second wheel chair wheel of the manual wheelchair,
and if so,
maintaining with the automated wheelchair assistance apparatus with the first motor the motion of the manual wheelchair wheel at the measured wheel velocity in the current direction and allowing a turning motion of the manual wheelchair with no additional push or breaking required by the user for the manual wheelchair movement,
and if not,
adjusting with the automated wheelchair assistance apparatus a first velocity of the first wheel chair wheel with the first motor to maintain the measured wheel velocity of the first wheel, and adjusting with the automated wheelchair assistance apparatus a second velocity of the second wheel chair wheel with the second motor to the measured wheel velocity of the first wheel chair wheel providing a straight motion of the manual wheel chair in the desired direction with no additional pushing or breaking required by the user for the manual wheelchair movement,
and if not,
the wheel chair wheel of the manual wheelchair is not moving so no motion assistance for the manual wheelchair is necessary.

21. A method for automated wheelchair assistance, comprising:
receiving a first selection input on an automated wheelchair assistance apparatus from one or more touch sensors for one or more outer wheelchair wheels on a manual wheelchair, wherein the first selection input includes a user of the manual wheelchair starting touching a first time of the one or more outer wheels of the manual wheelchair;
determining from the automated wheelchair assistance apparatus with a motion controller connected to an electronic circuit on the automated wheelchair assistance apparatus, whether the manual wheelchair is accelerating, and if so,
determining from the automated wheelchair assistance apparatus via the electronic circuit from the motion controller, a value for a level of the acceleration of the manual wheelchair, and
turning on power from automated wheelchair assistance apparatus to the first motor and the second motor from the electronic circuit to move the manual wheelchair in a desired direction, thereby creating automatic push assistance of the manual wheelchair at a desired velocity based on the determined value for the level of the acceleration of the manual wheelchair;
receiving a second selection input on the automated wheelchair assistance apparatus from the one or more touch sensors, wherein the second selection input includes the user of the manual wheelchair stopping touching of the one or more outer wheels of the manual wheelchair;
continuing applying power from the automated wheelchair assistance apparatus to the first motor and the second motor to continue maintaining manual wheelchair in the desired direction at the desired velocity until a third selection input is received on the one more touch sensors indicating on the motion controller on the automated wheelchair assistance apparatus that manual wheelchair is deaccelerating,
wherein, the third selection input includes the user of the manual wheelchair starting touching a second time of the one or more outer wheels of the manual wheelchair.

22. A method for automated wheelchair assistance, comprising:
receiving a first selection input on an automated wheelchair assistance apparatus from one or more touch sensors for one or more outer wheelchair wheels on a manual wheelchair, wherein the first selection input includes a user of the manual wheelchair starting touching a first time of the one or more outer wheels of the manual wheelchair;
determining from the automated wheelchair assistance apparatus with a motion controller connected to an electronic circuit on the automated wheelchair assistance apparatus, whether the manual wheelchair is deaccelerating, and if so,
determining from the automated wheelchair assistance apparatus via the electronic circuit from the motion controller, a value for a level of the deacceleration of the manual wheelchair, and
adjusting power from automated wheelchair assistance apparatus to the first motor and the second motor from the electronic circuit to move the manual wheelchair in a desired direction, thereby creating automatic braking assistance of the manual wheelchair at a desired velocity based on the determined value for the level of the deacceleration of the manual wheelchair;
receiving a second selection input on the automated wheelchair assistance apparatus from the one or more touch sensors, wherein the second selection input includes the user of the manual wheelchair stopping touching of the one or more outer wheels of the manual wheelchair;
continuing adjusting power from the automated wheelchair assistance apparatus to the first motor and the second motor to continue maintaining the manual wheelchair in the desired direction at the desired velocity until a third selection input is received on the one more touch sensors indicating on the motion controller on the automated wheelchair assistance apparatus that manual wheelchair is accelerating,
wherein the third selection input includes the user of the manual wheelchair starting touching a second time of the one or more outer wheels of the manual wheelchair.

23. A method for automated wheelchair assistance, comprising:
receiving a first selection input on an automated wheelchair assistance apparatus from one or more touch sensors for one or more wheelchair wheels on a manual wheelchair, wherein the first selection input includes a user of the manual wheelchair touching one or more wheels of the manual wheelchair;
determining with the electrical circuit on the electronic circuit a type of contact and a contact point for the touching of the one or more wheels of the manual wheelchair; and
determining from the automated wheelchair assistance apparatus with a motion controller connected to the electronic circuit on the automated wheelchair assistance apparatus, with the determined type of contract and contact point, whether the manual wheelchair is accelerating or deaccelerating,
if the manual wheelchair is accelerating,
determining from the automated wheelchair assistance apparatus via the electronic circuit from the motion controller, a first value for a level of the acceleration of the manual wheelchair, and
turning on power with the determined first value from automated wheelchair assistance apparatus to the first motor and the second motor from the electronic circuit to move the manual wheelchair in a desired direction,
thereby creating automatic push assistance of the manual wheelchair at a desired first velocity based on the determined first value for the level of the acceleration of the manual wheelchair, and
if the manual wheel chair is deaccelerating,
determining from the automated wheelchair assistance apparatus via the electronic circuit from the motion controller, a second value for a level of the deacceleration of the manual wheelchair, and
adjusting power with the determined second value from automated wheelchair assistance apparatus with to the first motor and the second motor from the electronic circuit to move the manual wheelchair in the desired direction,
thereby creating automatic braking assistance of the manual wheelchair at a desired second velocity based on the determined second value for the level of the deacceleration of the manual wheelchair.
